(19) United States
(12) Patent Application Publication
(10) Pub. No.: US 2010/0169556 A1
(43) Pub. Date: Jul. 1, 2010

(54) NONVOLATILE STORAGE DEVICE, INFORMATION RECORDING SYSTEM, AND INFORMATION RECORDING METHOD

(75) Inventors: Kenichi Nakanishi, Tokyo (JP); Keiichi Tsutsui, Tokyo (JP); Junichi Koshiyama, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/644,686

(22) Filed: Dec. 22, 2009

(30) Foreign Application Priority Data
Dec. 25, 2008 (JP) 2008-330883

(51) Int. Cl. G06F 12/00; G06F 12/02

(52) U.S. Cl. 711/103; 707/822; 711/E12.001; 711/E12.008; 707/E17.01

(57) ABSTRACT

A nonvolatile storage device includes a nonvolatile memory configured to store user data and management information used to manage the user data on a file system, and a medium controller configured to determine whether a command input from a host device is used for the user data or the management information, the command describing content of processing performed for the user data or the management information, and switch between control methods used for the nonvolatile memory on the basis of the determination result.

### BACKGROUND OF THE INVENTION

1. Field of the Invention

The invention relates to a nonvolatile storage device including a nonvolatile memory device and capable of storing data in a safe condition, an information recording system including a nonvolatile storage device, and an information recording method.

2. Description of the Related Art

Recently, auxiliary storage devices such as memory cards have been produced as media used to record file data which was usually stored in media such as magnetic disks, as the storage capacity of nonvolatile storage devices (called “media” hereinafter) including semiconductor memory devices and being electrically rewritable has increased. Especially, since NAND-type flash memories having a large storage capacity can be produced at low cost, NAND-type flash memories are used in digital cameras and mobile-phone units.

FIG. 30 shows a storage system including a medium and an information recording apparatus (called “host” hereinafter) which functions as a host device that reads and writes data from and onto the medium.

The storage system includes a host 400 and a medium 300. The medium 300 includes a medium controller 310 and a nonvolatile memory device (NVM: Non-Volatile Memory) 350. The medium controller 310 includes a host interface 320, a NVM control section 330, and a NVM INTERFACE 340. On the basis of information included in predetermined protocol data received through the host interface 320, the medium controller 310 controls the nonvolatile memory device 350 with the NVM control section 330 and realizes a function as a storage device.

The host 400 includes a buffer section for buffering user data and management information used to control the storage device and outputs the buffered user data and the buffered management information to the medium 300. At this time, the host 400 outputs the buffered user data and the buffered management information to the medium 300 by using the same method (the same protocol), the protocol having no means for discriminating the user data from the management information. Various kinds of information recording apparatuses such as the above-described digital camera, the above-described mobile-phone unit, and a personal computer are applied to the host 400.

In the storage system, the host 400 uses a predetermined protocol used to access the medium 300. FIG. 31 shows a software layer in the host 400.

As shown in FIG. 31, the software layer mainly includes an application 450, a file system 460, and a medium-control driver 470. When a file access is executed in response to an operation performed by a user, the application 450 instructs accessing of a file through the file system 460.

Data in the medium 300, which the host 400 accesses by using the file system 460, includes two types of data such as user data and management information used by the file system. The user data is data file created by a user using an application. On the other hand, the management information is important data used to manage all the user data stored in the medium. At present, a FAT (File Allocation Tables) file system is known as a file system, for example. Taking the example of a FAT file system, the management information includes BPB (BIOS Parameter Block), PBR (Partition Boot Record), FAT1, FAT2, a root directory, and a directory. The two types of data are allocated in one storage space in relation to the host.

The file system 460 includes a management-information control section 461 and a user-data access section 462. The management-information control section 461 and the user-data access section 462 perform control (access control) of the management information and the user data, respectively. Then, the file system 460 outputs a data-access instruction to the medium-control driver 470.

The medium-control driver 470 is software that controls a medium control section not shown in FIG. 31 and outputs a medium control command and a parameter to the medium interface 480 in response to the data-access instruction supplied from the file system 460. At this time, the management information and the user data are output to the medium-control driver 470.

The medium interface 480 outputs medium-access protocol data to the medium 300 in response to a data-access instruction supplied from the medium-control driver 470. Data output to the medium 300 is output according to a transmission pattern (sequence) of a read/write command used by an application.

For example, a transmission pattern (sequence) of a read/write command transmitted from the host 400 includes READ_DATA as a command used to read data from the medium 300 or WRITE_DATA as a command used to write data to the medium 300. FIGS. 32A and 32B show flowcharts illustrating two types of processing for the medium 300 performed in response to a read command and a write command, respectively. In the case of read processing, as shown in FIG. 32A, the NVM control section 330 detects, for example, a READ_DATA command (Step S231) and performs read control on the nonvolatile memory device 350 (Step S232). At this time, confirmation of ECC (Error Correcting Code), namely, confirmation of errors in read data, is performed (Step S233). On the other hand, in the case of write processing, as shown in FIG. 32B, the NVM control section 330 detects, for example, a WRITE_DATA command (Step S235) and performs write control on the nonvolatile memory device 350 (Step S236). At this time, confirmation of the status of the nonvolatile memory device 350 is performed (Step S237).

Here, FIG. 33 shows an example of a storage space of the FAT file system as an example of a file system. The storage space exists as a successive address space in which a first address corresponds to zero on the basis of a sector (512 bytes) as an access unit. Taking the example of the FAT file system, in a logically-formatted storage space, the BPB is allocated to the first address, followed by the PBR, the FAT1, the FAT2, and the root directory as management information. User Data Area includes a directory and a file.

While the directory is a part of the management information, the directory is management information generated in response to a user's instruction. Then, an address to which the directory is allocated is determined on the basis of timing at which the directory is actually generated. While the FAT 2 exists as a copy of the FAT1, management information other than the FAT1 has no copy on the storage space. Therefore, when data errors occur, the management information other than the FAT1 may be lost and the file system may not normally function as a storage system.

In addition, the management information is stored in a smaller storage capacity than the user data and is accessed in a small amount. For example, in the case of file system FAT32, the size of FAT information necessary for managing 4 M bytes of the user data is 512 bytes (in the case that a cluster size is 32 K bytes).

Read-file access processing corresponding to the example of the file access shown in FIG. 31 will be described with reference to a flowchart shown in FIG. 34. When the host 400 detects that the medium 300 is loaded into a slot, the host 400 starts mount processing. First, the host 400 reads the BPB in the FAT file system (Step S201) and subsequently reads the PBR (Step S202). After that, the host 400 reads the root directory (Step S203). In this way, the BPB, the PBR, and the root directory are read once every time the medium 300 is mounted. Therefore, the number of accesses to the management information becomes particularly high.

Next, read-file access processing corresponding to the example of the data access shown in FIG. 31 will be described with reference to a flowchart shown in FIG. 35. In the medium 300, when a read-access instruction to a file is detected, first a directory in the FAT file system is read (Step S211) and subsequently the FAT1 is read (Step S212). After that, the user data is read (Step S213). Then, whether or not the user data is complete is determined (Step S214). When the user data is not yet complete, the processing returns to the read processing for the FAT1 in Step S212. When the user data is complete, the series of processing is terminated.

Next, write-file access processing corresponding to the example of the data access shown in FIG. 31 will be described with reference to a flowchart shown in FIG. 36. In the medium 300, when a write-access instruction to a file is detected, first a directory in the FAT file system is read (Step S221). Then, target user data is searched and written (Step S222). After writing the user data, content of the write processing performed for the user data is reflected in the FAT1 (Step S223). Subsequently, the content of the write processing performed for the user data is reflected in the FAT2 (Step S224). Then, whether or not the user data is complete is determined (Step S225). When the user data is not yet complete, the processing returns to the write processing for the user data in Step S222. When the user data is complete, a directory is written (Step S226) and the series of processing is terminated.

The FAT information is managed by allocating up to 32 bits to a cluster which is a management unit for data (in the case of FAT32). Therefore, in one sector in which the same FAT information is stored, 4096 bits (=32 bits×128; corresponding to 512 bytes) of data is managed. Then, every time these clusters are accessed, the FAT information stored in the sector is accessed once or more than once.

A specific example of the medium control and the parameter shown in FIG. 31 will be described with reference to FIG. 37. FIG. 37 is an example of actual commands (a sequence in write processing) issued from the host 400 to the medium 300. The commands issued by the host 400 include content of processing, a sector address in the medium, and information relating to the number of sectors. In the example, commands Nos. 1 to 3 and Nos. 9 to 11 are associated with access to the management information and the access to the management information is executed more than once.

Recently, a page size of a flash memory has been expanded to a size of 2 K to 4 K bytes. When such a memory is used, it is assumed that the number of accesses is further four to eight times higher on the basis of one page corresponding to four to eight sectors. In this way, since the number of accesses from the host to the management information in the file system is higher than the user data, the management information has a tendency to cause data errors in view of a data-retention characteristic.

In this situation, when electric power supply of the system is shut down during storing data from the host 400 to the medium 300, the interruption of data store causes a state that the data being under the data-store processing introduces a data error. In the case of a removable medium, when the removable medium is pulled out during data store, the same state arises.

FIG. 38 is a diagram illustrating the case that power-off arises during write-file-access processing (in relation to user data). In the medium 300, first, when a write-access instruction to a file is detected, a directory in the FAT file system is read (Step S241). Then, target user data 1 is searched and written (Step S242). After writing the user data 1, content of the write processing performed for the user data 1 is reflected in the FAT1 (Step S243). Subsequently, the content of the write processing performed for the user data 1 is reflected in the FAT2 (Step S244). In addition, when power-off arises during data-store processing for user data 2, data error occurs in the user data 2.

Next, the case that read processing is executed under the state in which data errors occur in the user data 2 will be described. FIG. 39 is a diagram illustrating read processing performed after the power-off described with reference to FIG. 38 arises. In the medium 300, first, when a read-access instruction to a file is detected, a directory in the FAT file system is read (Step S251) and subsequently the FAT1 is read (Step S252). After that, the user data 1 is read (Step S253). Next, when FAT1 is read (Step S254) and user data 2 is read, a read error occurs in the file because of the interrupted data-store processing (refer to FIG. 38). In this case, while only the file in which the read error occurs becomes inaccessible, other user data and management information are not affected by the read error.

Next, the case that power-off arises during data-store processing for a directory will be described. FIG. 40 is a diagram illustrating the case that power-off arises during write-file-access processing (in relation to directory). In the medium 300, first, when a write-access instruction to a file is detected, a directory in the FAT file system is read (Step S261). Then, target user data is searched and written (Step S262). After writing the user data, content of the write processing performed for the user data is reflected in the FAT1 (Step S263). Subsequently, the content of the write processing performed for the written user data is reflected in the FAT2 (Step S264). It is assumed that power-off arises while data-store processing for a directory is performed due to changing the user data (Step S265).

Next, the case that read processing is executed after data errors occur in the directory will be described. FIG. 41 is a diagram describing read processing performed after the power-off described with reference to FIG. 38 arises. In the medium 300, when a read-access instruction to a file is detected, a directory in the FAT file system is read (Step S271). However, a read error occurs during directory access. In addition to the file whose data-store processing interrupted by the power-off, all files existing in the same directory become inaccessible. When data errors occur in BPB or PBR, the medium 300 becomes unrecognized as a medium and all user data becomes inaccessible.

Since the number of accesses to the management information is higher than the user data, the management information, in view of a data-retention characteristic, has higher probability to cause data errors than the user data according to the above-mentioned contributing factor. When data errors occur in the management information, the data errors cause a larger confusion and larger damage to a user than data errors occurring in a user data. Therefore, it is necessary to more securely record and store management information in a medium than user data and to prevent data errors from occurring so that a storage system having high reliability for a user may be realized.

While recently storage capacity of a memory device has become large with the development of semiconductor process, a characteristic of a memory cell has become deteriorated. The deteriorated characteristic of the memory cell is one of contributing factors which raise the probability of soft errors or data errors occurring during the above-mentioned concentration of access.

FIG. 42 shows another example relating to an internal configuration of a medium of the related art. Compared with the example shown in FIG. 30, the example shown in FIG. 42 includes a cache area used for high-speed processing and a medium controller 310A dealing with cache processing. Namely, the medium controller 310A includes a cache-use NVM control section 332 in addition to a user-data-use NVM control section 331.

FIG. 43 shows another example relating to an internal configuration of a medium of the related art, namely, an example including a cache-compliant memory device (hybrid). The medium includes a cache-use nonvolatile memory device 360 in addition to a usual nonvolatile memory device 350B. Then, with installation of two types of memory devices, the medium includes NVM interfaces 341 and 342 used for the respective memory devices.

FIG. 44 is a flowchart illustrating processing for READ_DATA performed in the media shown in FIGS. 42 and 43. In the medium 300, when a command used for READ_DATA is detected in a sequence transmitted from the host 400, whether or not target data is data on the cache is determined (Step S271). When the target data is not data on the cache, the user-data-use NVM control section 331 reads the target data from the nonvolatile memory device 350 or 350B (Step S272). On the other hand, when the target data is data on the cache, the cache-use NVM control section 332 reads the target data from a predetermined cache area or the cache-use nonvolatile memory device 360 (Step S273).

FIG. 45 is a flowchart illustrating processing for WRITE_DATA performed in the media shown in FIGS. 42 and 43. In the medium 300, when a command used for WRITE_DATA is detected in a sequence transmitted from the host 400, whether or not free space used to write target data exists in the cache is determined (Step S281). When no free space exists in the cache, the user-data-use NVM control section 331 makes free space in the cache (Step S282) and the processing proceeds to Step S283. On the other hand, When free space exists in the cache, the cache-use NVM control section 332 writes the target data in a predetermined cache area or the cache-use nonvolatile memory device 360 (Step S283).

However, it is difficult for the technologies shown in FIGS. 42 to 45 to prevent the number of accesses to the management information from becoming particularly high, more securely record and store management information in a medium than user data, and prevent data errors from occurring.

By the way, a patent document 1 (see Japanese Unexamined Patent Application Publication No. 2008-176677) describes a technology which, in order to prevent power-off from causing data errors, switches between two nonvolatile memory control means on the basis of whether or not a countermeasure against power-off is implemented.

### SUMMARY OF THE INVENTION

However, the technology described in the patent document 1 is not an adequate countermeasure against concentrated access to management information and a deteriorated characteristic of a memory cell. In addition, there is a problem that formats and contents of data stored in a memory are, as a result, different on the basis of whether or not a countermeasure against power-off is implemented.

In view of the above-identified circumstances, it is therefore desirable to take adequate countermeasures against concentrated access to management information and a deteriorated characteristic of a memory cell, more securely record and store management information in a medium than user data, and prevent data errors from occurring.

According to an embodiment of the present invention, a command input from a host device is received, the command describing whether data to be a processing object is user data or management information, and it is determined whether the received command is used for the user data or the management information. Switching between control methods used for nonvolatile memory means is performed on the basis of the determination result, the nonvolatile memory means storing the user data and the management information used to manage the user data on a file system. Then, the user data or the management information is recorded in the nonvolatile memory means according to the control method switched to.

In the above-mentioned configuration, since it can be prescribed that the command transmitted from the host device to a nonvolatile storage device is used for the management information, the nonvolatile storage device detects the prescription and switches to a control method capable of surely storing the management information in a safe condition.

In addition, in the above-mentioned configuration, the nonvolatile storage device includes a first nonvolatile memory configured to store the user data and a second nonvolatile memory configured to be more reliable at storing data than the first nonvolatile memory and store the management information used to manage the user data on the file system. Then, on the basis of the command which is input from the host device and describes whether data to be a processing object is the user data or the management information, a medium controller controls switching between the first nonvolatile memory and the second nonvolatile memory and storing data.

In the above-mentioned configuration, since a high-reliable nonvolatile memory is provided for the management information, the probability of data errors occurring in the management information is reduced.

In addition, in the above-mentioned configuration, by using a command describing whether data to be a processing object is the user data or the management information, the medium controller determines whether or not data input from the host is used for the management information. When the data is used for the management information, the medium controller controls appending of an error-correcting code to the management information and storing the management information in the nonvolatile memory, the error-correcting code having higher error correcting capability than the user data.

In the above-mentioned configuration, since the error-correcting code with higher error correcting capability is appended to the management information, the probability of data errors occurring in the management information is reduced.

In addition, in the above-mentioned configuration, by using a command describing whether data to be a processing object is the user data or the management information, the medium controller determines whether or not data input from the host is used for the management information. When the data is used for the management information, the medium controller controls writing of the management information twice in the nonvolatile memory.

In the above-mentioned configuration, since the same management information is written at two points (double writing), the management information may be stored in a safe condition at either of the two points and data errors may be prevented from occurring.

### BRIEF DESCRIPTION OF THE DRAWINGS

FIG. 1 is a block diagram illustrating an internal configuration of a medium according to a first embodiment of the present invention;

FIG. 2 is a block diagram illustrating an internal configuration of a NVM control section shown in FIG. 1;

FIG. 3 is a block diagram illustrating an internal configuration of a host according to the first embodiment of the present invention;

FIG. 4 is a diagram illustrating a software layer in the host shown in FIG. 3;

FIG. 5 is a flowchart illustrating read/write processing performed by the medium shown in FIG. 1;

FIG. 6 is a diagram illustrating a command example (1) according to the first embodiment of the present invention;

FIG. 7 is a flowchart illustrating processing for the medium performed in response to SET_MNG command;

FIG. 8 is a flowchart illustrating processing for the medium performed in response to CLR_MNG command;

FIG. 9 is a diagram illustrating a command example (2) according to the first embodiment of the present invention;

FIG. 10 is a flowchart illustrating discrimination processing performed in a protocol discrimination section in response to the command shown in FIG. 9;

FIG. 11 is a diagram illustrating a command example (3) according to the first embodiment of the present invention;

FIG. 12 is a flowchart illustrating discrimination processing performed in the protocol discrimination section in response to the command shown in FIG. 11;

FIG. 13 is a diagram illustrating a command example (4) according to the first embodiment of the present invention;

FIG. 14 is a flowchart illustrating discrimination processing performed in the protocol discrimination section in response to the command shown in FIG. 13;

FIG. 15 is a block diagram illustrating an internal configuration of a medium according to a second embodiment of the present invention;

FIG. 16 is a block diagram illustrating an internal configuration of a medium according to a third embodiment of the present invention;

FIG. 17 is a block diagram illustrating an internal configuration of a medium according to a fourth embodiment of the present invention;

FIG. 18 is a flowchart illustrating read processing for the media shown in FIGS. 16 and 17;

FIG. 19 is a flowchart illustrating write processing for the media shown in FIGS. 16 and 17;

FIG. 20 is a flowchart illustrating processing for the media shown in FIGS. 16 and 17 performed in response to SET_MNG command;

FIG. 21 is a flowchart illustrating processing for the media shown in FIGS. 16 and 17 performed in response to CLR_MNG command;

FIG. 22 is a diagram illustrating a NVM control algorithm used for management information according to a fifth embodiment of the present invention;

FIG. 23 is a flowchart illustrating read processing based on the NVM control algorithm-1 shown in FIG. 22;

FIG. 24 is a flowchart illustrating write processing based on the NVM control algorithm-1 shown in FIG. 22;

FIG. 25 is a diagram illustrating a case that power-off arises during processing based on the NVM control algorithm shown in FIG. 24;

FIG. 26 is a flowchart illustrating read processing (2) based on the NVM control algorithm-2 shown in FIG. 22;

FIG. 27 is a flowchart illustrating write processing (2) based on the NVM control algorithm-2 shown in FIG. 22;

FIG. 28 is a diagram illustrating a case that power-off arises during processing based on the NVM control algorithm shown in FIG. 27;

FIG. 29 is a block diagram illustrating an internal configuration of a host computer according to a sixth embodiment of the present invention;

FIG. 30 is a block diagram illustrating an internal configuration (1) of a medium of the related art;

FIG. 31 is a diagram illustrating a software layer in a host computer shown in FIG. 30;

FIG. 32A is a flowchart illustrating processing for a medium performed in response to a read command;

FIG. 32B is a flowchart illustrating processing for the medium performed in response to a write command;

FIG. 33 is a diagram illustrating an example of a storage space of a FAT file system as an example of a file system;

FIG. 34 is a flowchart illustrating mount processing;

FIG. 35 is a flowchart illustrating read-file access processing;

FIG. 36 is a flowchart illustrating write-file access processing;

FIG. 37 is a diagram illustrating an example of a sequence in write processing;

FIG. 38 is a diagram illustrating a case that power-off arises during write-file-access processing (in relation to user data);

FIG. 39 is a diagram illustrating a case that an error occurs during read-file access processing (in relation to user data) after power-off arises during write-file-access processing (in relation to user data);

FIG. 40 is a diagram illustrating a case that power-off arises during write-file-access processing (in relation to directory);

FIG. 41 is a diagram illustrating a case that an error occurs during read-file access processing (in relation to directory) after power-off arises during write-file-access processing (in relation to directory);

FIG. 42 is a block diagram illustrating an internal configuration (2) of a medium of the related art;

FIG. 43 is a block diagram illustrating an internal configuration (3) of a medium of the related art;

FIG. 44 is a flowchart illustrating processing for READ_DATA performed in the media shown in FIGS. 42 and 43; and

FIG. 45 is a flowchart illustrating processing for WRITE_DATA performed in the media shown in FIGS. 42 and 43.

### DESCRIPTION OF THE PREFERRED EMBODIMENTS

Hereinafter, preferred embodiments of the present invention will be described with reference to figures. In addition, the preferred embodiments will be described in the sequence as below.

1. a first embodiment (memory device: an example including two types of memory devices used for user data and management information respectively)

2. a second embodiment (memory device: an example including one memory device used for both user data and management information)

3. a third embodiment (NVM control section: an example including a nonvolatile cache area)

4. a fourth embodiment (NVM control section: an example including a volatile cache area used for user data)

5. a fifth embodiment (an example including switching between NVM control algorithms)

6. a sixth embodiment (an example relating to a configuration in which a host and a medium are integrated)

### 1. First Embodiment

An information recording apparatus (called “host” hereinafter), functioning as a host device that reads and writes data from and onto a medium, and a storage system including a medium will be described. The medium is a nonvolatile storage device including a semiconductor memory device and being electrically rewritable. Various kinds of information recording apparatuses such as the aforementioned digital camera, the aforementioned mobile-phone unit, and the aforementioned personal computer are applied to the host.

According to an embodiment of the present invention, whether data in the medium, which the host accesses, is user data or management information can be determined by the medium. The medium includes a section configured to store data while switching between two types of memory devices, namely, a large-capacity memory device used for the user data and a small-capacity memory device used for the management information. In addition, a nonvolatile memory device may be called “NVM” hereinafter.

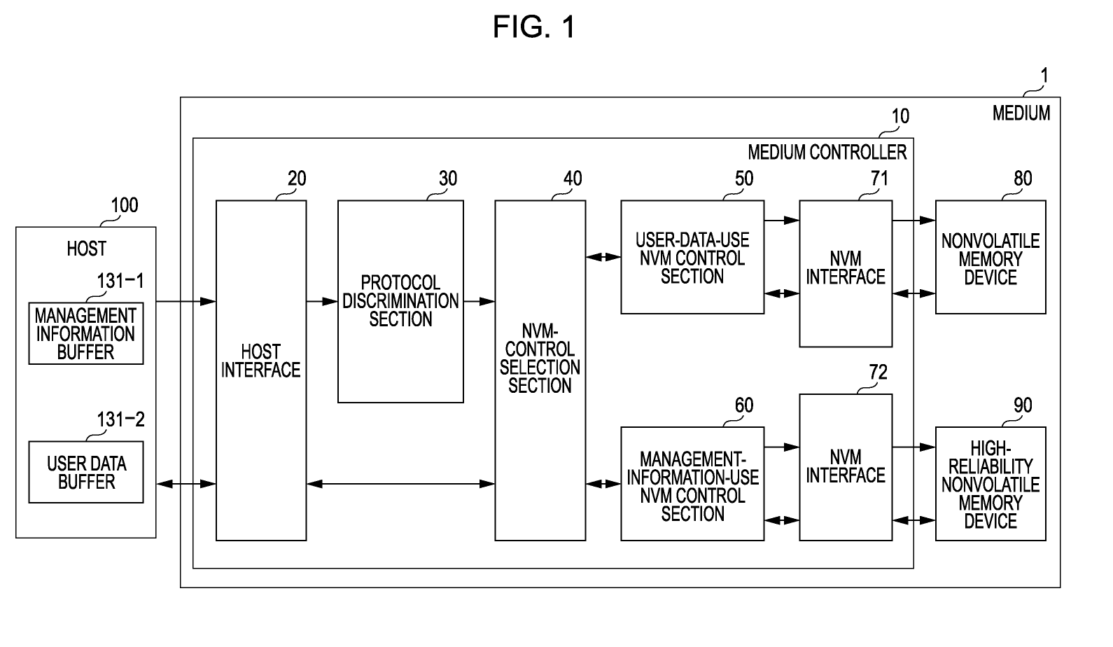

FIG. 1 is a block diagram illustrating an internal configuration of a medium according to the first embodiment of the present invention. The storage system includes a host 100 and a medium 1. The medium 1 includes a medium controller 10, a nonvolatile memory device (NVM) 80, and a high-reliability nonvolatile memory device 90. The medium controller 10 includes a host interface 20, a protocol discrimination section 30, a NVM-control selection section 40, a user-data-use NVM control section 50, a management-information-use NVM control section 60, and NVM interfaces 71 and 72.

The protocol discrimination section 30 determines a protocol to be used for data received from the host 100 through the host interface 20 and outputs the determination result to the NVM-control selection section 40. The NVM-control selection section 40 selects one of the two NVM control sections for use on the basis of the determination result and switches between the two NVM control sections. The selected NVM control section controls a corresponding memory device and reads or writes data on the memory device. In this way, operation as a storage device is realized. The operation of the protocol discrimination section 30 will be described hereinafter.

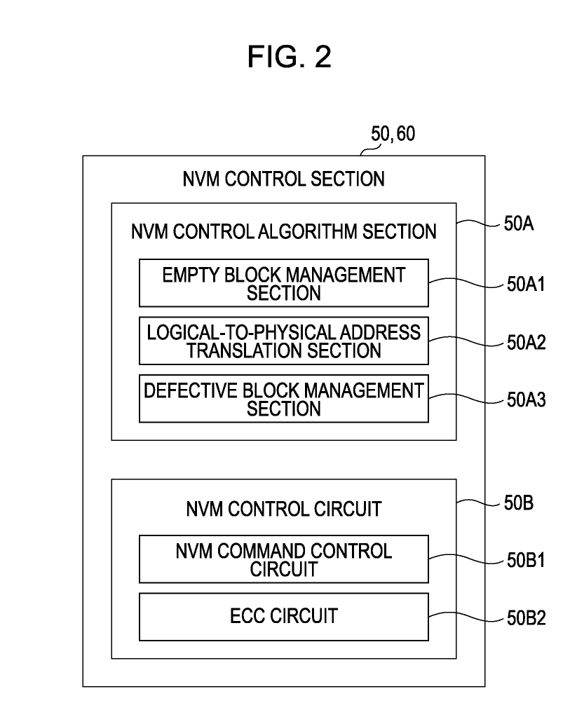

FIG. 2 is a block diagram illustrating internal configurations of the user-data-use NVM control section 50 and the management-information-use NVM control section 60. Since the configurations of the two NVM control sections are the same, common description will be made with reference to FIG. 2. The NVM control section is utilized for realizing storage functions such as Read, Write, Erase, and Copy with respect to the nonvolatile memory device and includes a NVM control algorithm section 50A and a NVM control circuit 50B, both used to control a NVM. Since a configuration of the NVM control section is an existing one, the configuration will be described briefly.

The NVM control algorithm section 50A includes an empty block management section 50A1, a logical-to-physical address translation section 50A2, and a defective block management section 50A3. The empty block management section 50A1 manages the status of use in the nonvolatile memory device. Then, the logical-to-physical address translation section 50A2 translates a logical address to a physical address with reference to a logical-to-physical address translation table which translates a logical address specified by the host 100 to a physical address used in the nonvolatile memory device. In addition, the defective block management section 50A3 manages defective blocks occurring in the nonvolatile memory device. The defective blocks are controlled in the medium 1 in order not to be utilized as areas used to store data transmitted from the host 100.

In addition, the NVM control circuit 50B includes a NVM command control circuit 50B1 and an ECC (Error Correcting Code) circuit 50B2. The NVM control section is different according to the nonvolatile memory device. Furthermore, the NVM control section is different according to user-data use, management-information use, and cache use. The NVM command control circuit 50B1 performs read/write processing on the nonvolatile memory device on the basis of content of processing described by a command. The ECC circuit 50B2 appends an error-correcting code (called “ECC data” hereinafter), which is used to correct errors, to data received from the host 100.

### Configuration Example of Host

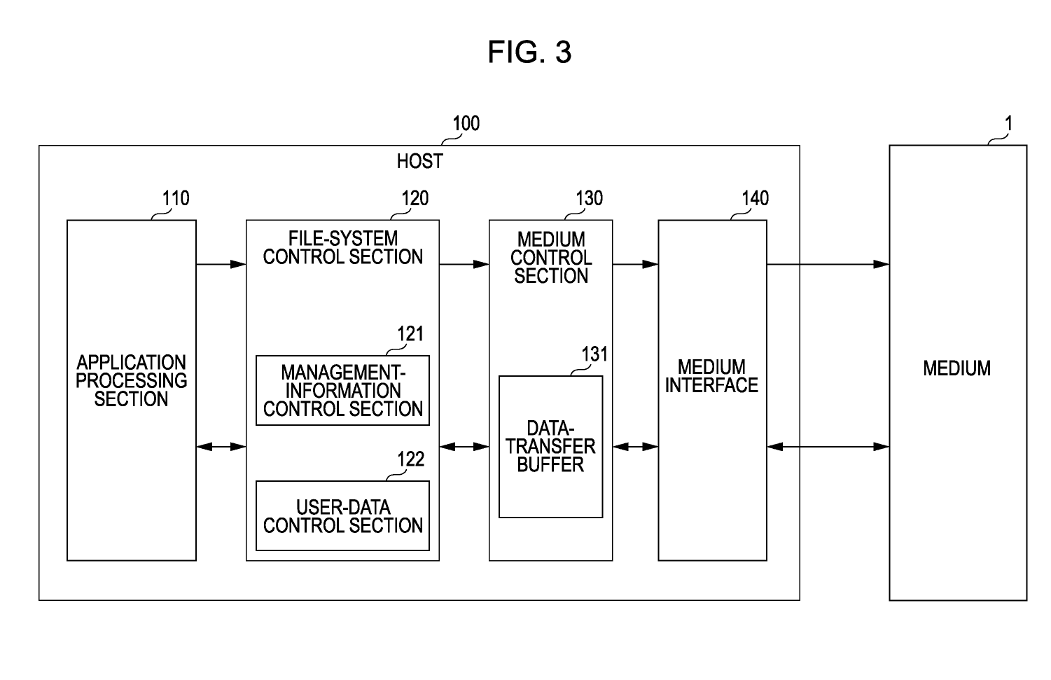

FIG. 3 is a block diagram illustrating an internal configuration of the host. The host 100 includes an application processing section 110, a file-system control section 120, a medium control section 130, and a medium interface 140. The file-system control section 120 includes a management-information control section 121 and a user-data control section 122. The medium control section 130 includes a data-transfer buffer 131 including a management-information buffer section 131-1 and a user-data buffer section 131-2.

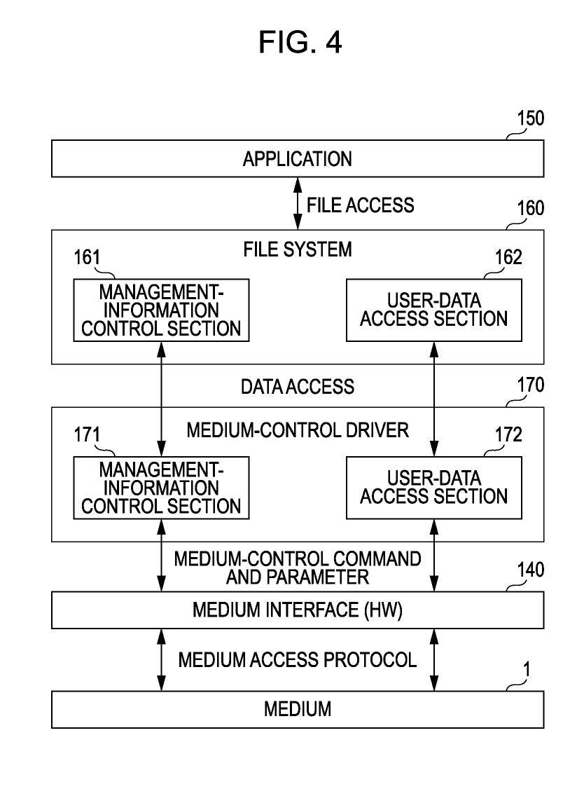

FIG. 4 is a diagram illustrating a software layer in the host shown in FIG. 3. As shown in FIG. 4, the software layer includes an application 150, a file system 160, and a medium-control driver 170 corresponding to blocks in FIG. 3 respectively. When a file access is performed according to a user's operation, the application 150 instructs a file access through the file system 160.

Data in the medium 1, which the host 100 accesses by using the file system 160, includes two types of data such as user data and management information used for a file system. The user data is a data file created by a user utilizing an application. On the other hand, the management information is important data used to manage all user data stored on the medium. At present, taking the example of the FAT file system, the management information includes BPB (BIOS Parameter Block), PBR (Partition Boot Record), FAT1, FAT2, a root directory, and a directory. The two types of data are allocated in one storage space from the standpoint of the host.

In the file system 160, a management-information control section 161 and a user-data access section 162 control (access control) the management information and the user data, respectively. Then, the file system 160 outputs respective data-access instructions used for the management information and the user data to the medium-control driver 170.

The medium-control driver 170 is software that controls the medium control section 130. Then, when the medium-control driver 170 receives the data-access instruction from the file system 160, the medium-control driver 170 outputs a medium-control command and a parameter to the medium interface 140. According to an embodiment of the present invention, the management information and the user data are, as data having different protocols respectively, output to the medium-control driver 170 and the medium 1 can determine whether data is the management information or the user data.

When the medium interface 140 receives a data-access instruction from the medium-control driver 170, the medium interface 140 outputs data having a medium-access protocol to the medium 1. Namely, the medium interface 140 outputs the management information and the user data, which are buffered by the management-information buffer section 131-1 and the user-data buffer section 131-2 respectively, to the medium 1 in synchronization. The data output to the medium 1 includes a transmission pattern (sequence) of a read/write command used in an application.

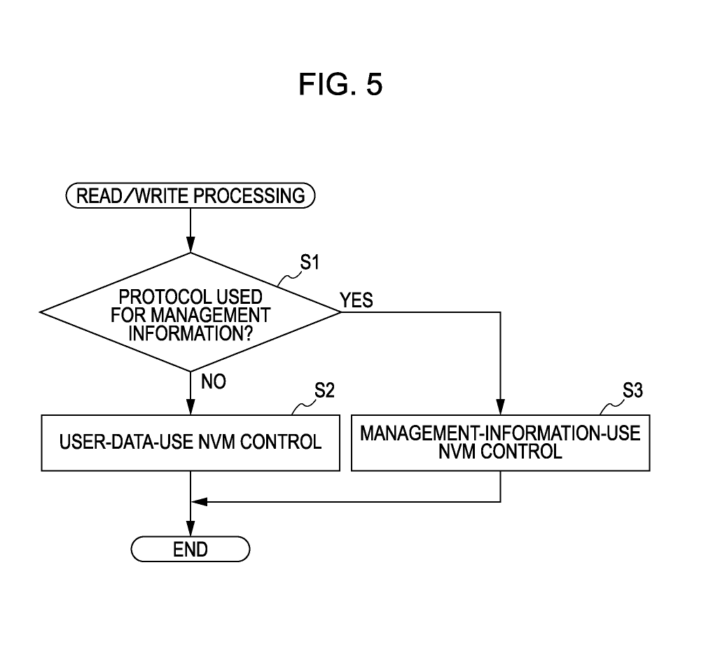

FIG. 5 is a flowchart illustrating read/write processing performed by the medium 1. When the medium 1 receives a read/write sequence from the host 100, whether or not a command in the sequence received by the protocol discrimination section 30 corresponds to a protocol used for the management information is determined (Step S1). When the command does not correspond to the protocol used for the management information, the user-data-use NVM control section 50 controls the nonvolatile memory device 80 (Step S2). On the other hand, when the command corresponds to the protocol used for the management information, the management-information-use NVM control section 60 controls the high-reliability nonvolatile memory device 90 (Step S3).

According to an embodiment of the present invention, as a protocol used to store data from the host to the medium, specific forms of two types of protocols used for the user data and the management information are as follows:

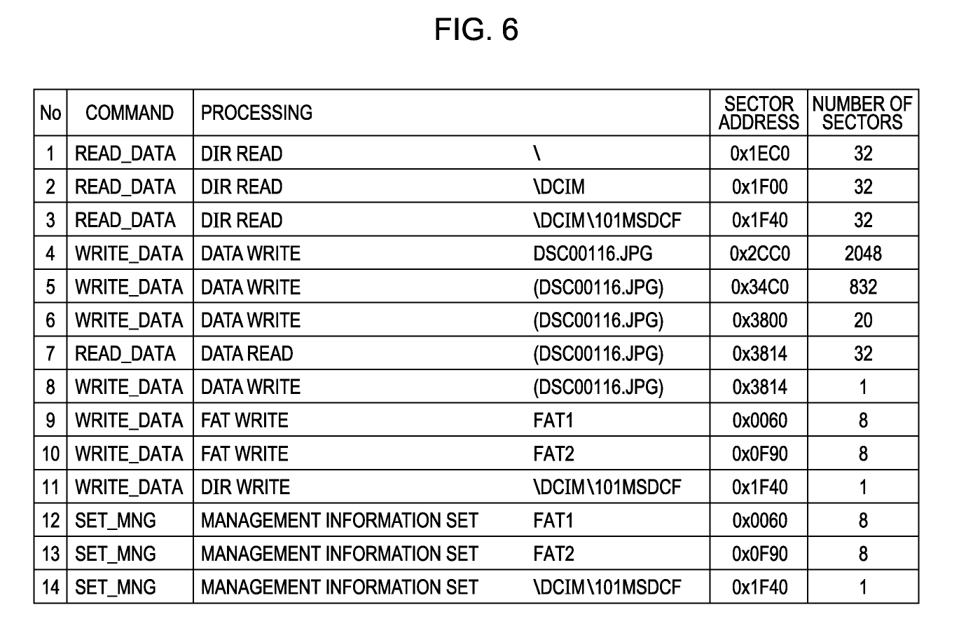

(1) an example of a command used to set or cancel the condition that data is the management information (in FIG. 6)

Without changing data in a designated sector area, the condition that data is the management information can be set or cancelled.

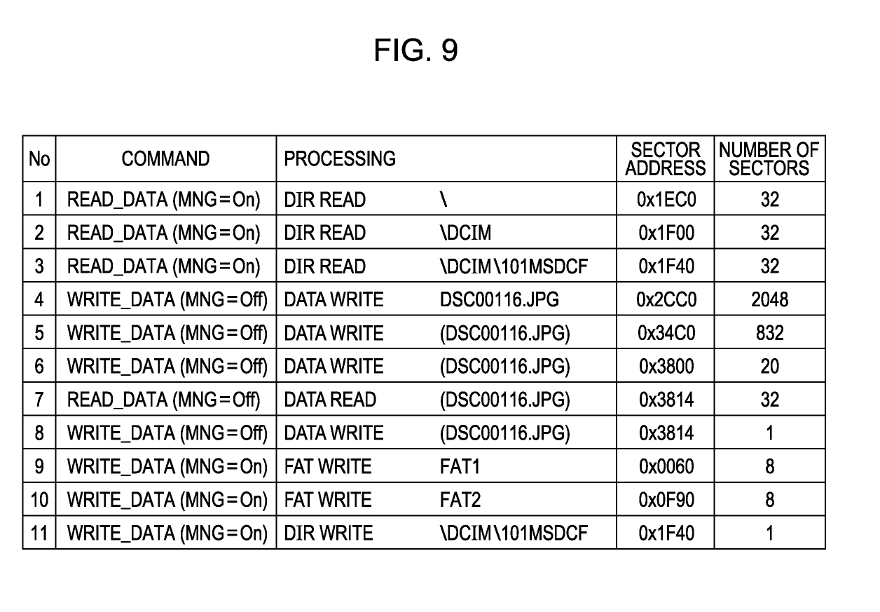

(2) while the management information and the user data use a common command, the condition that data is the management information is specified with a parameter (in FIG. 9)

Setting of the condition and storing of actual data can be performed simultaneously.

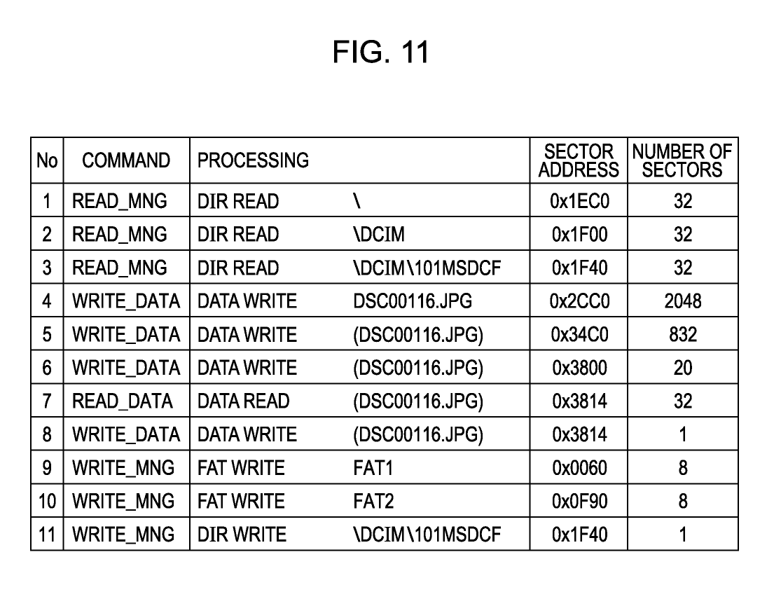

(3) an example in which the management information and the user data use dedicated access commands respectively (in FIG. 11)

While this case (3) has the same advantage as the case (2), a command format is different between the case (2) and the case (3).

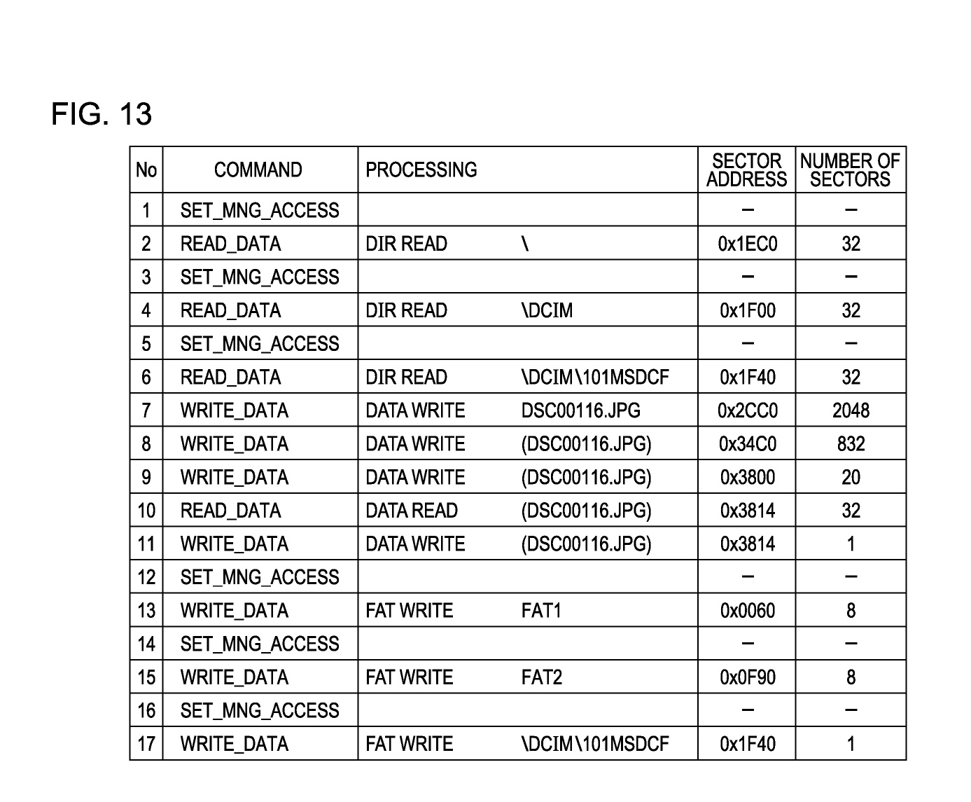

(4) an example of a command used to set the condition that a command to be executed next is a management-information access (in FIG. 13)

### First Protocol

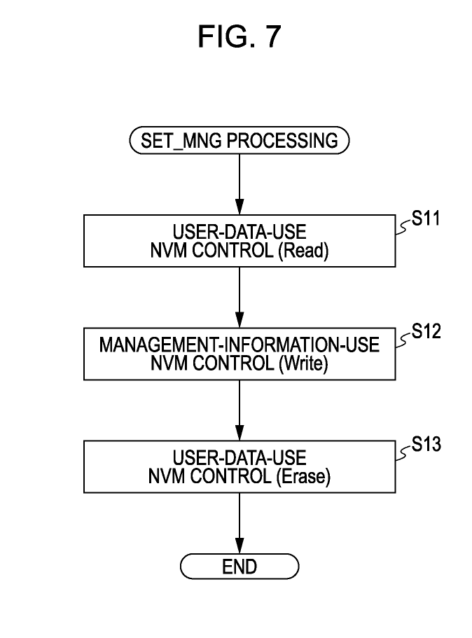

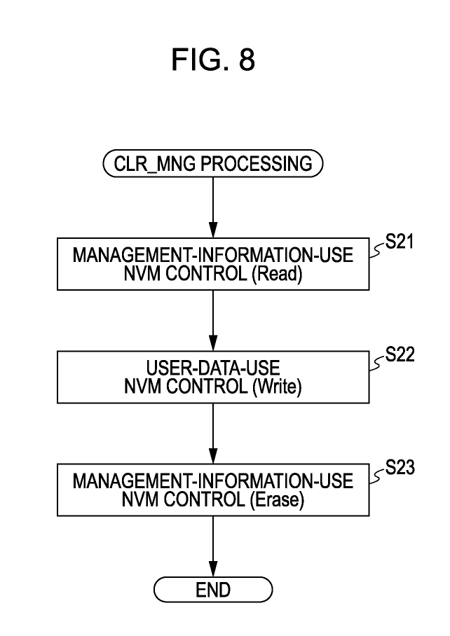

FIG. 6 is a diagram illustrating a sequence example (1) transmitted from the host 100 to the medium 1. The example is a method used to specify a management information area as a data attribute accessed by a command. For example, a command (protocol) such as SET_MNG (sector address, number of sectors) or CLR_MNG (sector address, number of sectors) is used. The SET_MNG is a command used to set the condition that data stored in the address is the management information. Then, the CLR_MNG is a command used to set the condition that data stored in the address is not the management information. FIGS. 7 and 8 show flowcharts used for description of these commands. FIG. 7 illustrates processing for changing a data attribute from the user data to the management information. FIG. 8 illustrates processing for changing a data attribute from the management information to the user data. Since the storing method performed on the nonvolatile memory device for changing the data attribute is different between the management information and the user data, it is necessary to read data by using a method corresponding to a data attribute before changing the data attribute and write the data by using a method corresponding to a data attribute after changing the data attribute.

Processing for changing a data attribute from the user data to the management information (processing for medium performed in response to SET_MNG command) will be described with reference to a flowchart shown in FIG. 7. When the protocol discrimination section 30 detects a SET_MNG command, the NVM-control selection section 40 switches to the user-data-use NVM control section 50 first and the user-data-use NVM control section 50 controls read processing for the user data (Step S11). Next, the NVM-control selection section 40 switches to the management-information-use NVM control section 60 and the management-information-use NVM control section 60 controls write processing for the management information (Step S12). Finally, the NVM-control selection section 40 switches to the user-data-use NVM control section 50 and the user-data-use NVM control section 50 controls erase processing for the user data (Step S13).

Processing for changing a data attribute from the management information to the user data (processing for medium performed in response to CLR_MNG command) will be described with reference to a flowchart shown in FIG. 8. When the protocol discrimination section 30 detects a CLR_MNG command, the NVM-control selection section 40 switches to the management-information-use NVM control section 60 first and the management-information-use NVM control section 60 controls read processing for the user data (Step S21). Next, the NVM-control selection section 40 switches to the user-data-use NVM control section 50 and the user-data-use NVM control section 50 controls write processing for the user data (Step S22). Finally, the NVM-control selection section 40 switches to the management-information-use NVM control section 60 and the management-information-use NVM control section 60 controls erase processing for the management information (Step S23).

In an actual access to a sector, a command which is the same as a command of the related art can be used for the management information and the user data. In the protocol, an attribute of data can be changed after the data is stored and using the protocol in combination with other protocol is effective.

### Second Protocol

FIG. 9 is a diagram illustrating a sequence example (2) transmitted from the host 100 to the medium 1. The example is a method used to set an attribute at the same time as access from the host 100 to the medium 1. For example, a command (protocol) such as WRITE_DATA (sector address, number of sectors, MNG flag) or READ_DATA (sector address, number of sectors, MNG flag) is used. Then, an attribute of data to be processed by the command is discriminated with a value given as a parameter.

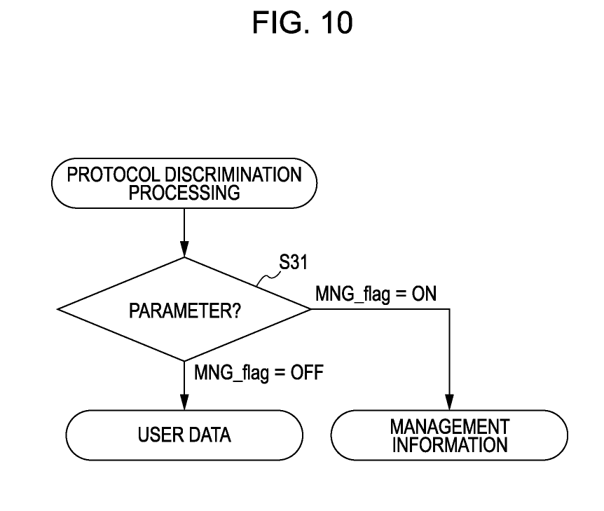

FIG. 10 is a flowchart illustrating discrimination processing performed in the protocol discrimination section in response to a command using the second protocol. When the medium 1 receives a read/write sequence from the host 100, the protocol discrimination section 30 determines, on the basis of a parameter of a command, whether or not the command in the received sequence corresponds to a protocol used for the management information (Step S31). When a MNG flag is off, it is determined that the command is for the user data. Therefore, the user-data-use NVM control section 50 is selected so as to control the nonvolatile memory device 80. On the other hand, when a MNG flag is on, it is determined that the command is for the management information. Therefore, the management-information-use NVM control section 60 is selected so as to control the high-reliability nonvolatile memory device 90.

### Third Protocol

FIG. 11 is a diagram illustrating a sequence example (3) transmitted from the host 100 to the medium 1. Like the second protocol, the example is a method used to set an attribute at the same time as access from the host 100 to the medium 1. For example, a command (protocol) such as WRITE_MNG (sector address, number of sectors) or READ_MNG (sector address, number of sectors) is used. Then, by analyzing an operation code, it is determined whether or not the command performs processing for the management information.

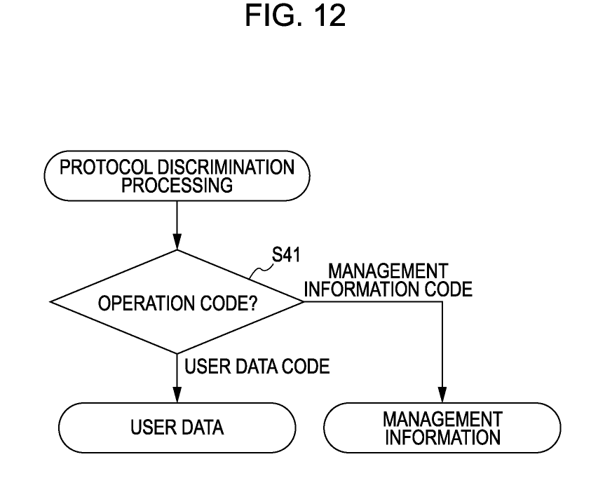

FIG. 12 is a flowchart illustrating discrimination processing performed in the protocol discrimination section in response to a command using the third protocol. When the medium 1 receives a read/write sequence from the host 100, the protocol discrimination section 30 determines, by analyzing an operation code, whether or not the command in the received sequence corresponds to a protocol used for the management information (Step S41). When the analysis result indicates that the command corresponds to a user-data code, it is determined that the command is for the user data. Therefore, the user-data-use NVM control section 50 is selected so as to control the nonvolatile memory device 80. On the other hand, when the analysis result indicates that the command corresponds to a management-information code, it is determined that the command is for the management information. Therefore, the management-information-use NVM control section 60 is selected so as to control the high-reliability nonvolatile memory device 90.

### Fourth Protocol

FIG. 13 is a diagram illustrating a sequence example (4) transmitted from the host 100 to the medium 1. The example is a method used to set an attribute of an access command to management information access. For example, a command (protocol) such as SET_MNG_ACCESS ( ) is used.

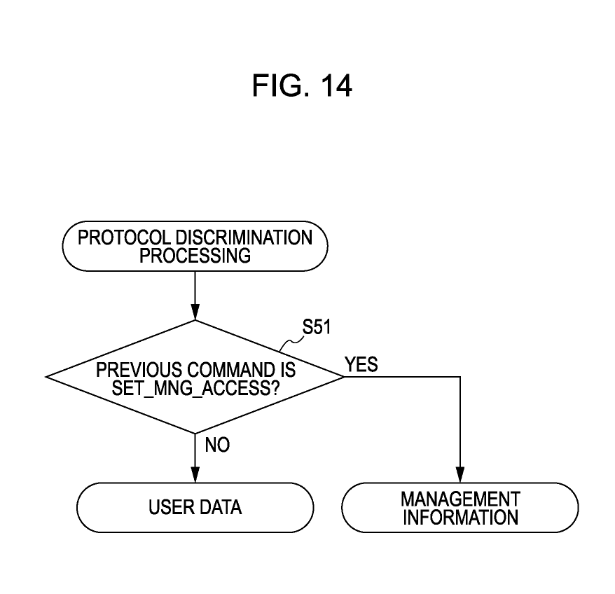

FIG. 14 is a flowchart illustrating discrimination processing performed in the protocol discrimination section in response to a command using the fourth protocol. When the medium 1 receives a read/write sequence from the host 100, the protocol discrimination section 30 determines, by analyzing an operation code, whether or not the command in the received sequence corresponds to a protocol used for the management information (Step S51). When the analysis result indicates that a previous command is the SET_MNG ACCESS, it is determined that the command is for the management information. Therefore, the management-information-use NVM control section 60 is selected so as to control the high-reliability nonvolatile memory device 90. On the other hand, when the analysis result indicates that the command is a command other than the SET_MNG_ACCESS, it is determined that the command is for the user data. Therefore, the user-data-use NVM control section 50 is selected so as to control the nonvolatile memory device 80.

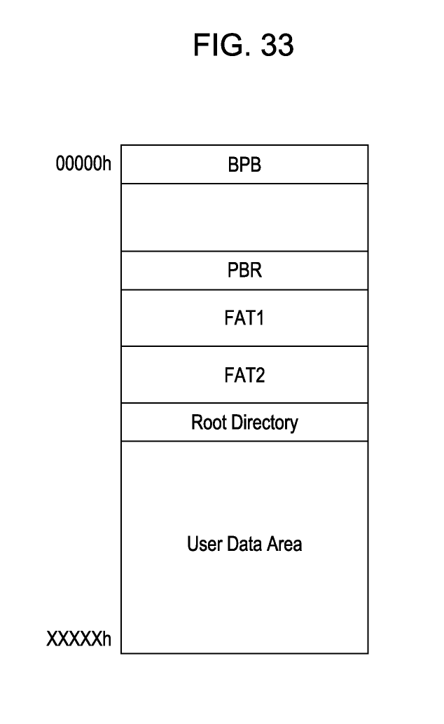

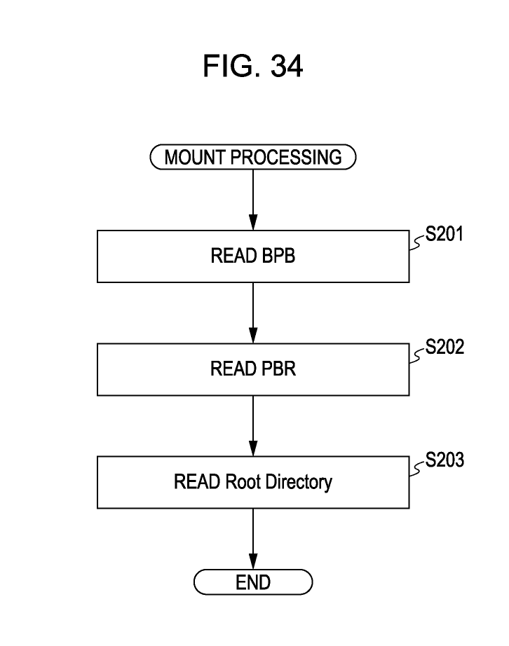

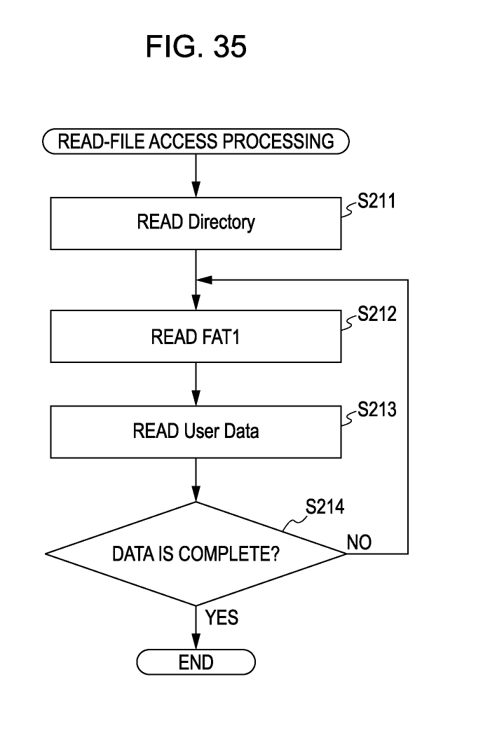

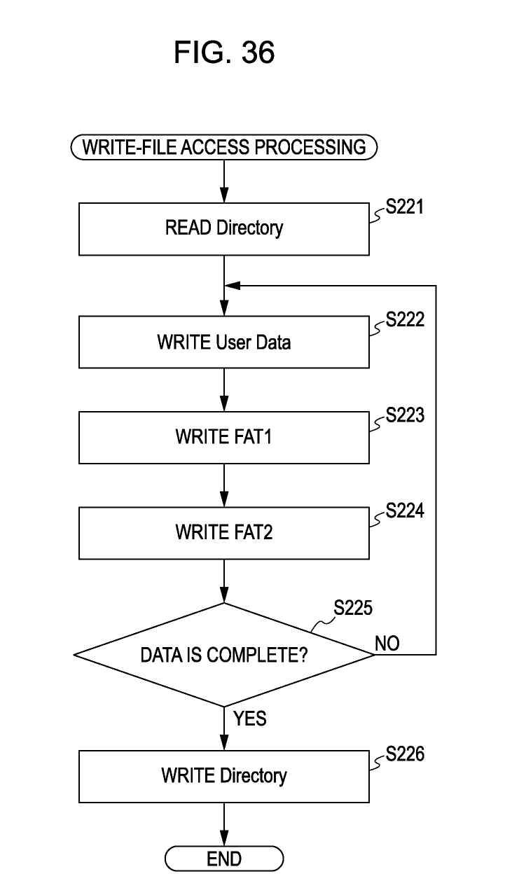

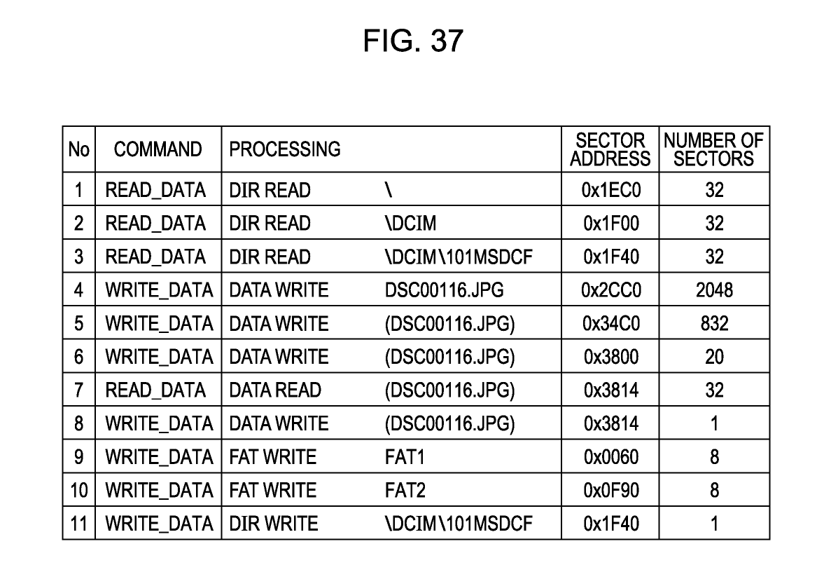

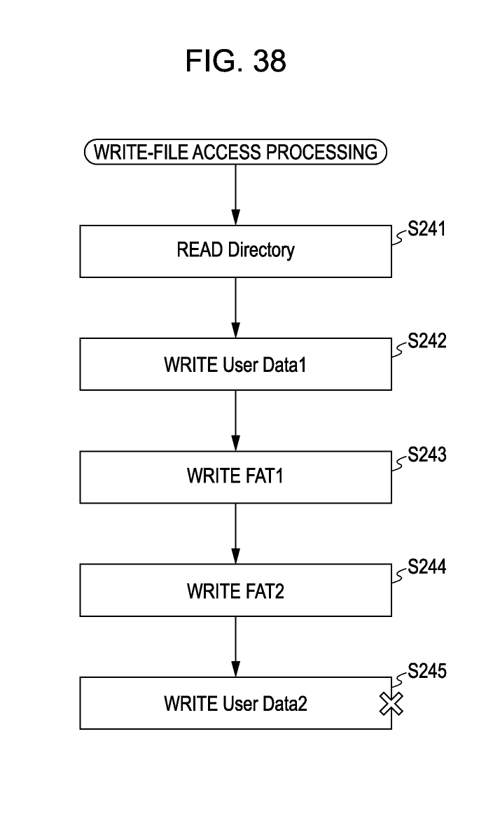

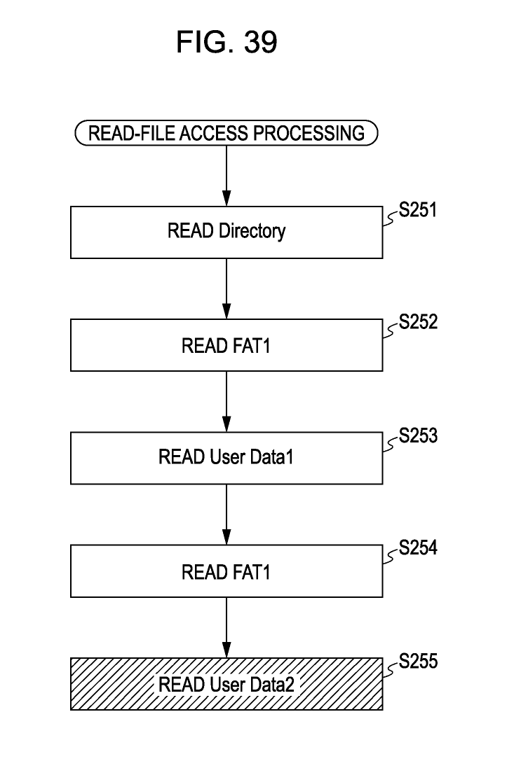

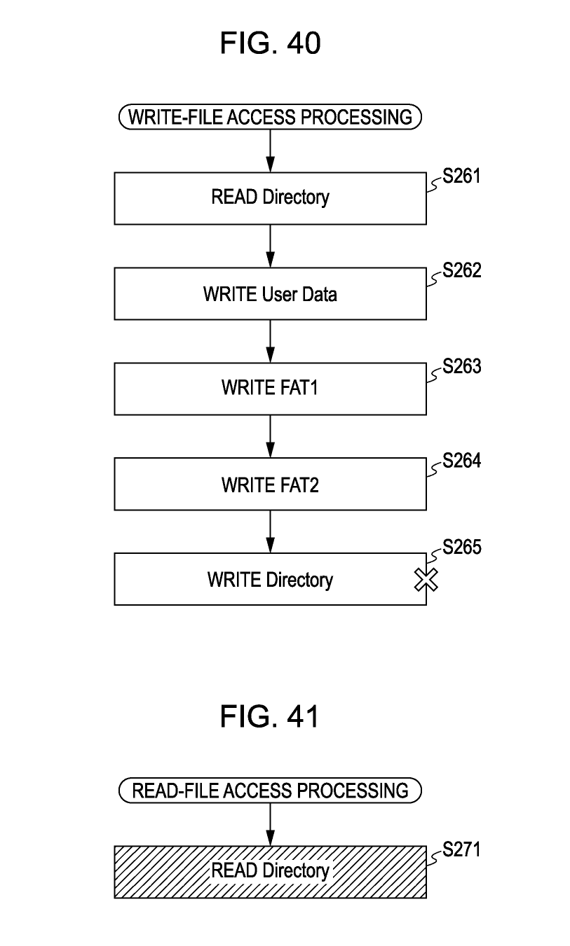

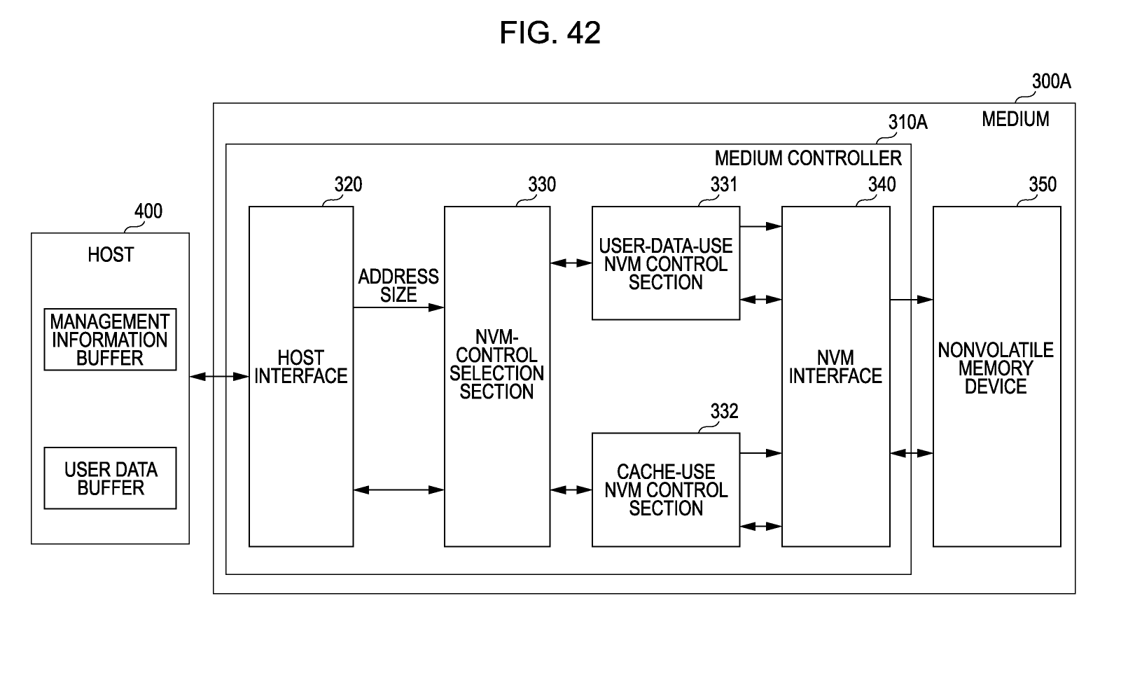

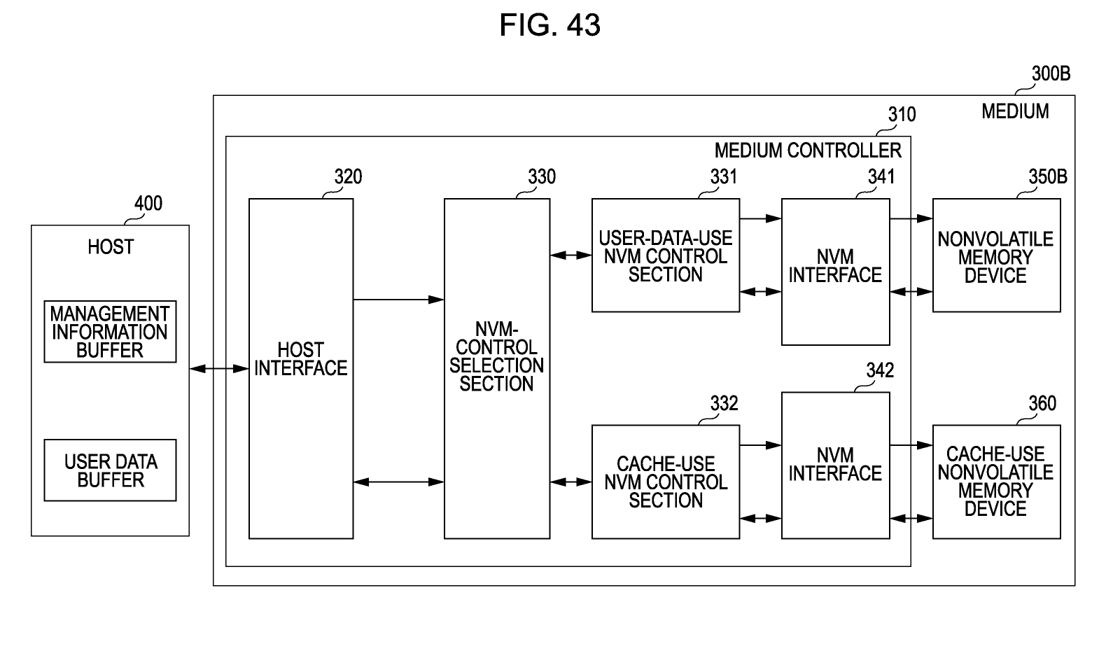

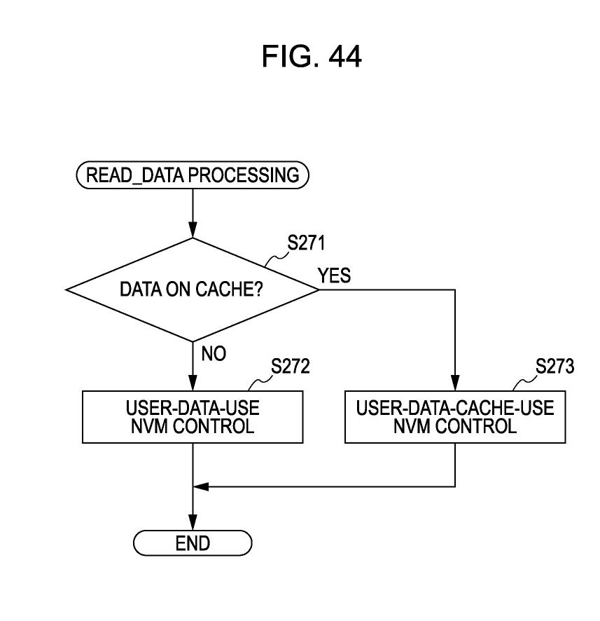

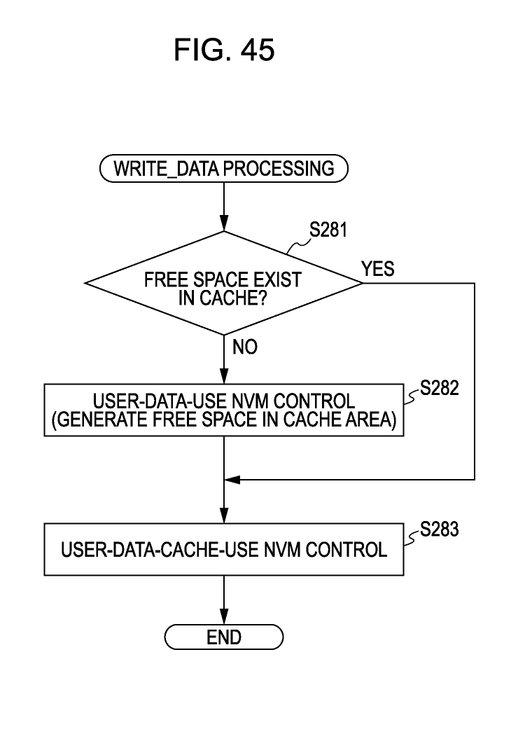

In the past, there has been no way for the medium to surely determine whether data transmitted from the host is the user data or the management information. Then, as shown in FIG. 33, by fixing addresses used for both a file system used by a system and a logical format map on a medium, whether or not the data is the management information may be determined on the basis of a sector address. However, since management information such as a directory whose sector addresses freely change exists, in relation to all management information it is difficult to determine whether or not the data is the management information. In addition, since addresses used for the management information change according to a file system, it is difficult for one medium to deal with a plurality of file systems. Then, a method used to determine the management information differs among file systems, which is one of reasons making it difficult for the medium to determinate the management information.

On the other hand, in the above-mentioned first embodiment, the medium includes a function to determine whether a protocol received from the host corresponds to the user data or the management information. Then, the medium selects a corresponding NVM control section on the basis of the determination result so as to access the nonvolatile memory device. Therefore, the host can specify whether the protocol corresponds to the user data or the management information. Accordingly, when important information dependent on an application exists in the user data, the medium can securely store the important information in the same way as the management information.

In the first embodiment according to the present invention, the probability of data errors occurring in the management information is reduced by taking adequate countermeasures against concentrated access to management information. In addition, while recently storage capacity of a memory device has become large with the development of semiconductor process, a data-retention characteristic of a memory has become deteriorated. Then, for example, even when the memory with the deteriorated data-retention characteristic is adopted as a memory used for the user data, a small-capacity memory device with a superior data-retention characteristic is adopted as a memory used for the management information. Therefore, data errors occurring in the management information is reduced. Specifically, a NOR-type memory is used for the management information and a NAND-type memory is used for the user data. In addition, a SLC (Single-Level-Cell) memory may be used for the management information and a MLC (Multi-Level Cell) memory may be used for the user data. Generally, a memory device used for the management information is more expensive than a memory device used for the user data.

In the first embodiment, in terms of storing the management information, a memory device used for the management information has a better characteristic than a memory device used for the user data. For example, a memory device with a superior data-retention characteristic, a memory device with a high guaranteed-rewrite count, or a memory device with a short program time or a short erase time is used for the management information. Then, a NVM control circuit used for a large capacity nonvolatile memory device is provided as a user-data-use NVM control section and a NVM control circuit used for a high-reliability nonvolatile memory device is provided as a management-information-use NVM control section.

### 2. Second Embodiment

In a second embodiment, a same nonvolatile memory device is used for user data and management information. In addition, the size of area in which an error-correcting code used for the management information is stored is extended. Then, the management information to which an error-correcting code is appended is stored, the error-correcting code having a higher error correcting capability than that appended to the user data.

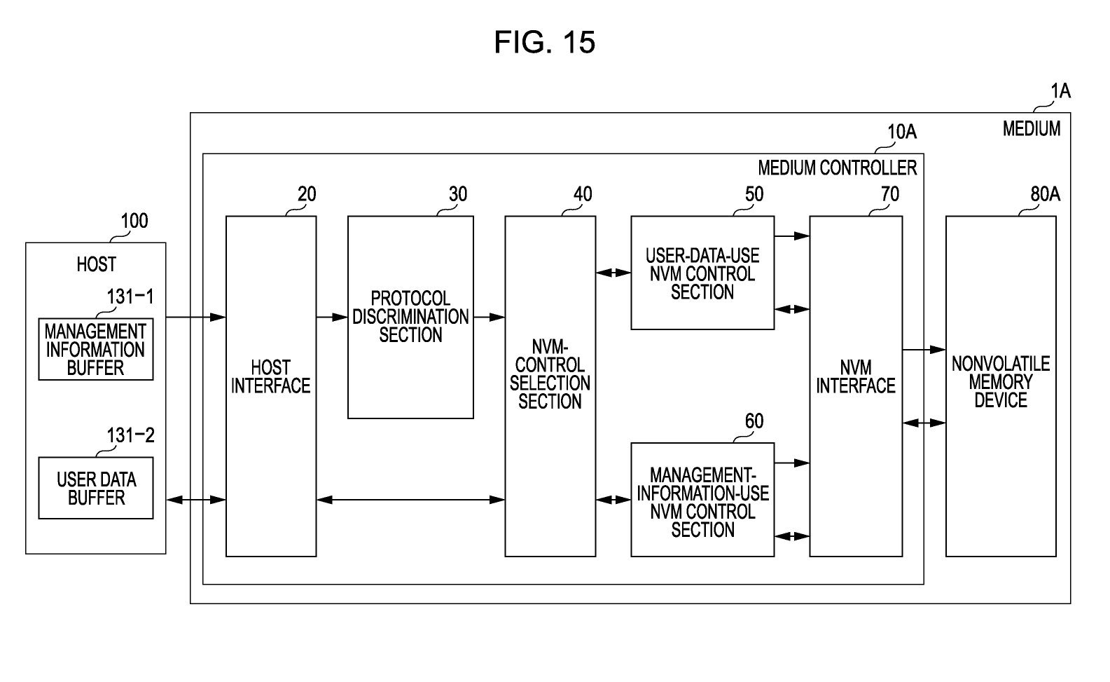

FIG. 15 is a block diagram illustrating an internal configuration of a medium according to the second embodiment of the present invention. Compared with the first embodiment (in FIG. 1), the example includes a same nonvolatile memory device 80A used for both a user-data-use memory device and a management-information-use memory device. Data transmission between a medium controller 10A and the nonvolatile memory device 80A is performed through a NVM interface 70. Then, an ECC circuit 50B2 included in the management-information-use NVM control section 60 has a higher error correcting capability than that appended to the user data. Accordingly, since the data size of the generated ECC code becomes large, an area used for the ECC code is secured on the nonvolatile memory device 80A.

In this way, in the second embodiment, the probability of data errors occurring in the management information is reduced by taking an adequate countermeasure against concentrated access to the management information, the countermeasure being that the management information, to which the error-correcting code having a higher error correcting capability than that appended to the user data is appended, is stored. As a result, the second embodiment has a similar function and an effect as the first embodiment.

### 3. Third Embodiment

In a third embodiment, NVM control sections in the medium controller include nonvolatile cache areas respectively.

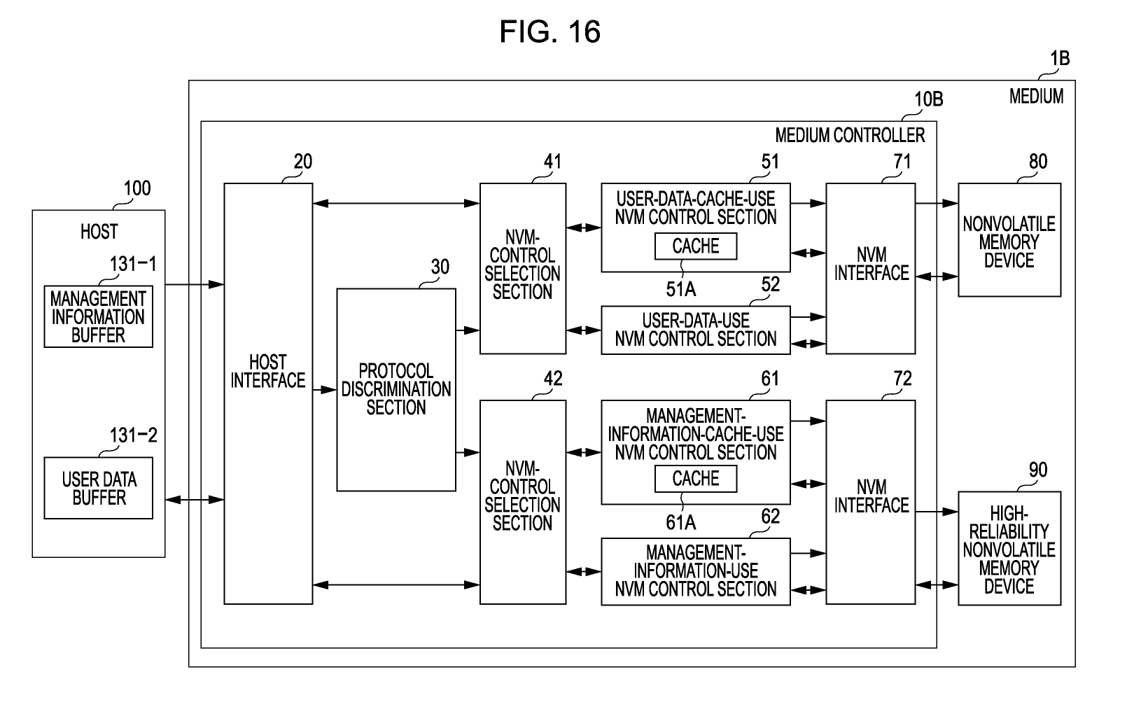

FIG. 16 is a block diagram illustrating an internal configuration of a medium according to the third embodiment of the present invention. In the third embodiment, a medium controller 10B in a medium 1B includes a user-data-cache-use NVM control section 51, including a cache memory 51A, and a user-data-use NVM control section 52. In addition, the medium controller 10B includes a management-information-cache-use NVM control section 61, including a cache memory 61A, and a management-information-use NVM control section 62. Accordingly, since NVM-control selection sections are necessary for the user data and the management information respectively, NVM-control selection sections 41 and 42 are provided.

In the third embodiment, while the cache area may include a nonvolatile memory device in the same way as a memory for the user data, the installation of the nonvolatile memory device is aimed at speeding up access form the host and a control method used for the nonvolatile memory device is different from that used for the user data. The control method used for the nonvolatile memory device will be described hereinafter. Other sections in the third embodiment have similar functions and effects as the first embodiment.

### 4. Fourth Embodiment

In the fourth embodiment, NVM control sections in the medium controller include cache areas respectively. However, a high-speed accessible volatile memory with large capacity is adopted as the cache area used for the user data.

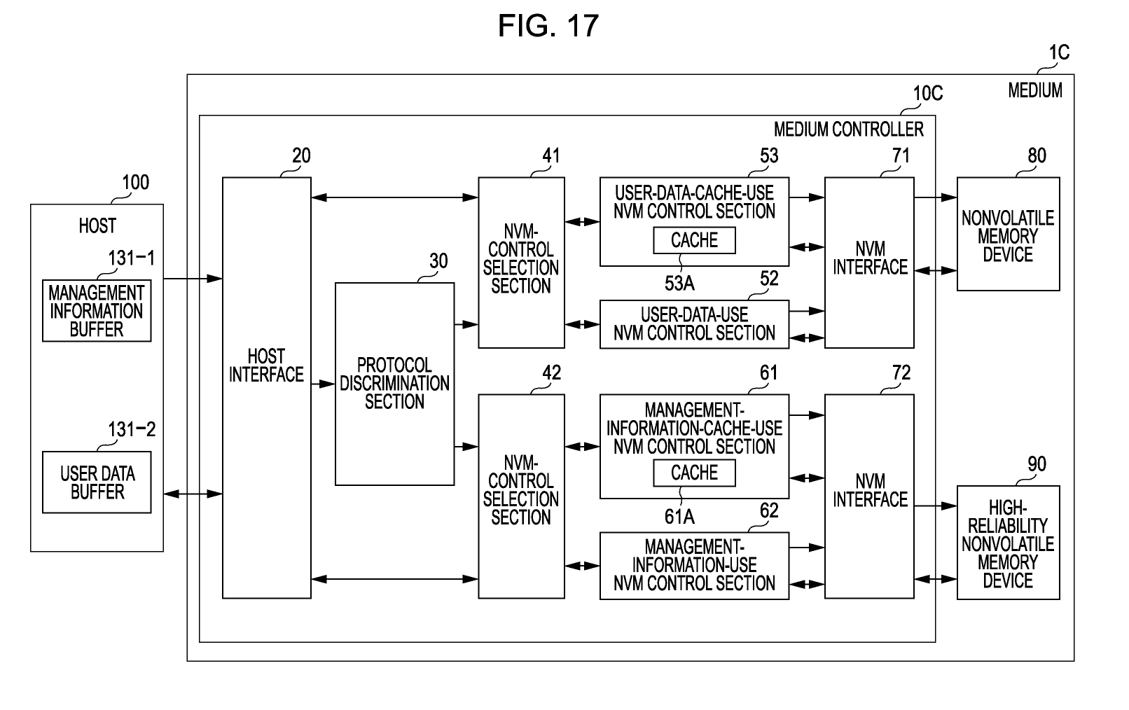

FIG. 17 is a block diagram illustrating an internal configuration of a medium according to the fourth embodiment of the present invention. In the fourth embodiment, a medium controller 10C in a medium 1C includes a user-data-cache-use NVM control section 53, including a cache memory 53A, and a user-data-use NVM control section 52. In addition, the medium controller 10C includes a management-information-cache-use NVM control section 61, including a cache memory 61A, and a management-information-use NVM control section 62.

In the fourth embodiment, compared with the third embodiment, security of the management information is retained and higher speed access to the user data can be performed. In this case, however, when power-off arises, user data yet to be written into a nonvolatile memory device disappears.

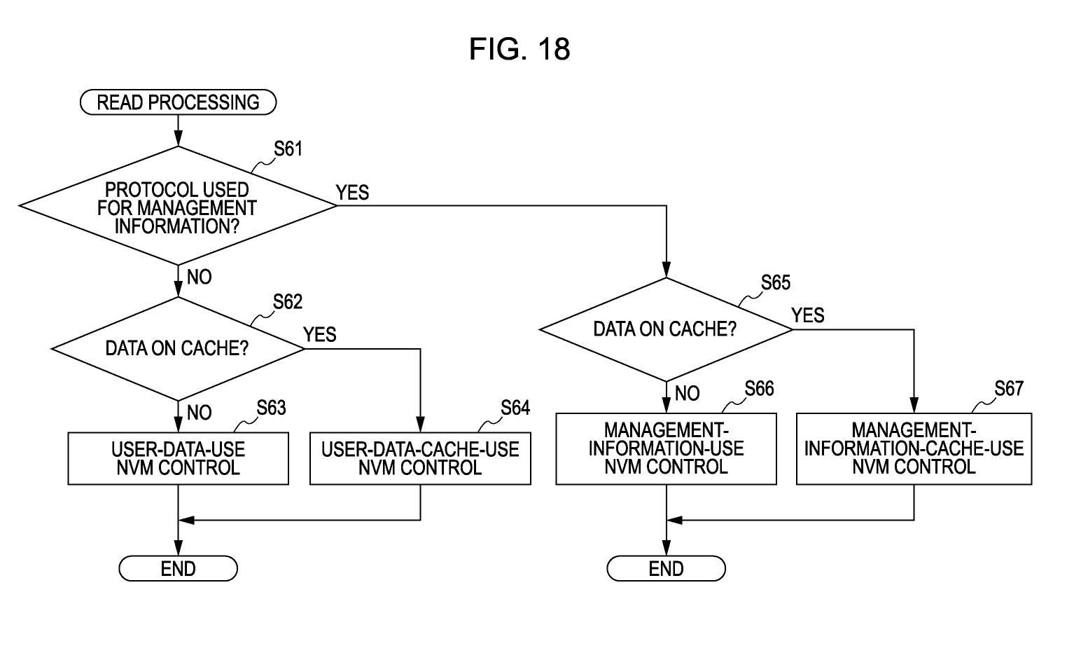

Next, operations of media shown in FIGS. 16 and 17 will be described. FIG. 18 is a flowchart illustrating read processing for the media shown in FIGS. 16 and 17. When the medium receives a read sequence from the host 100, whether or not a command in the sequence received by the protocol discrimination section 30 corresponds to a protocol used for the management information is determined (Step S61). When the command does not correspond to the protocol used for the management information, the processing proceeds to Step S62. On the other hand, when the command corresponds to the protocol used for the management information, the processing proceeds to Step S65.

When in Step S61 the command does not correspond to the protocol used for the management information, whether or not target data is data on the user-data cache memory is determined (Step S62). When the target data is not data on the user-data cache memory, the user-data-use NVM control section controls the nonvolatile memory device 80 (Step S63). On the other hand, when the target data is data on the user-data cache memory, the user-data-cache-use NVM control section reads the target data from the user-data cache memory (Step S64).

On the other hand, when in Step S61 the command corresponds to the protocol used for the management information, whether or not target data is data on the management-information cache memory is determined (Step S65). When the target data is not data on the management-information cache memory, the management-information-use NVM control section controls the high-reliability nonvolatile memory device 90 (Step S66). On the other hand, when the target data is data on the management-information cache memory, the management-information-cache-use NVM control section reads the target data from the management-information cache memory (Step S67).

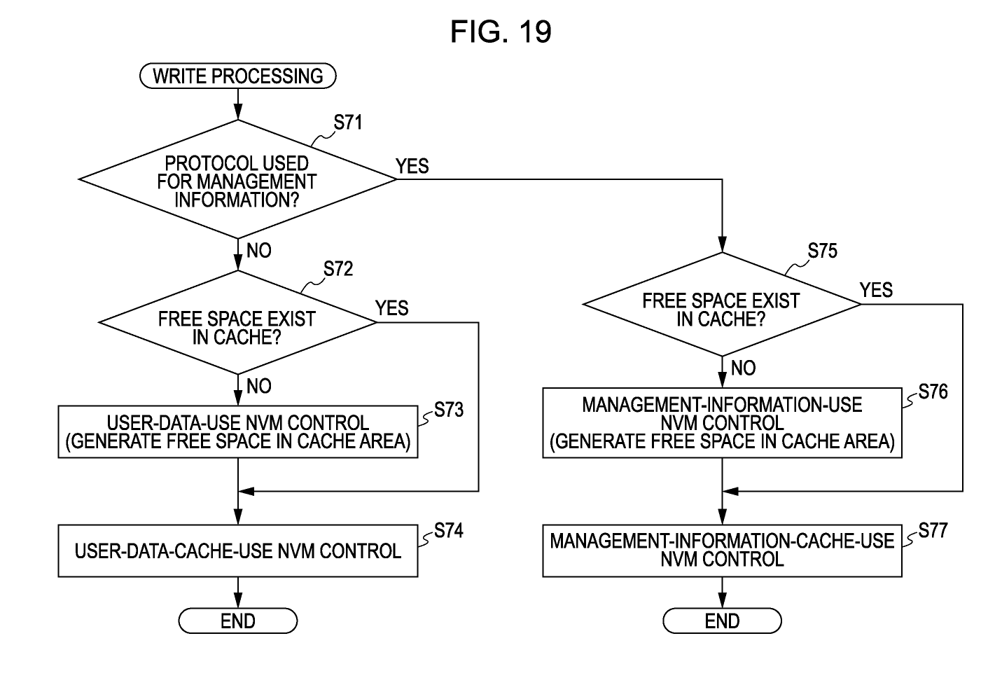

FIG. 19 is a flowchart illustrating write processing for the media shown in FIGS. 16 and 17. When the medium receives a write sequence from the host 100, whether or not a command in the sequence received by the protocol discrimination section 30 corresponds to a protocol used for the management information is determined (Step S71). When the command does not correspond to the protocol used for the management information, the processing proceeds to Step S72. On the other hand, when the command corresponds to the protocol used for the management information, the processing proceeds to Step S75.

When the command does not correspond to the protocol used for the management information in Step S71, the medium determines whether or not free space used to write target data exists in the user-data cache memory (Step S72). When no free space exists in the user-data cache memory, the user-data-use NVM control section makes free space in the cache area (Step S73) and the processing proceeds to Step S74. On the other hand, when free space exists in the cache area, the user-data-use NVM control section writes the target data in the cache area (Step S74).

On the other hand, when in Step S71 the command corresponds to the protocol used for the management information, the medium determines whether or not free space used to write target data exists in the management-information cache memory (Step S75). When no free space exists in the management-information cache memory, the management-information-use NVM control section makes free space in the cache area (Step S76) and the processing proceeds to Step S77. On the other hand, when free space exists in the cache area, the management-information-cache-use NVM control section writes the target data in the cache area (Step S77).

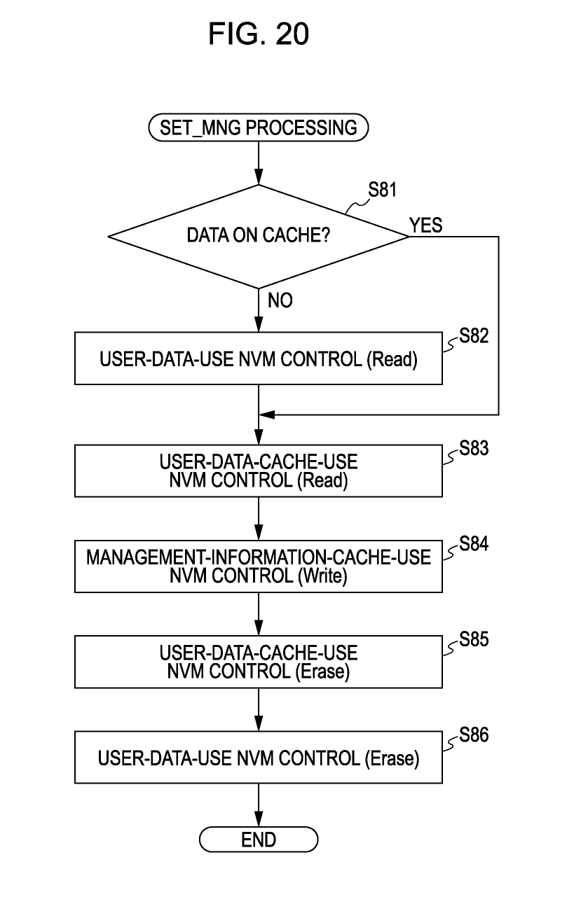

FIG. 20 is a flowchart illustrating processing for the media shown in FIGS. 16 and 17 performed in response to SET_MNG command. When the medium detects a SET_MNG command transmitted from the host 100, whether or not target data is data on the user-data cache memory is determined (Step S81). When the target data is not data on the user-data cache memory, the processing proceeds to Step S82. On the other hand, when the target data is data on the user-data cache memory, the processing proceeds to Step S83.

Next, the user-data-use NVM control section controls read processing for the user data (Step S82). Then, the user-data-cache-use NVM control section controls read processing for the user data (Step S83). Next, the NVM-control selection section switches to the management-information-cache-use NVM control section and the management-information-cache-use NVM control section controls write processing for the management information (Step S84). Finally, while the user-data-cache-use NVM control section controls erase processing for the user data (Step S85), the NVM-control selection section switches to the user-data-use NVM control section and the user-data-use NVM control section controls erase processing for the user data (Step S86).

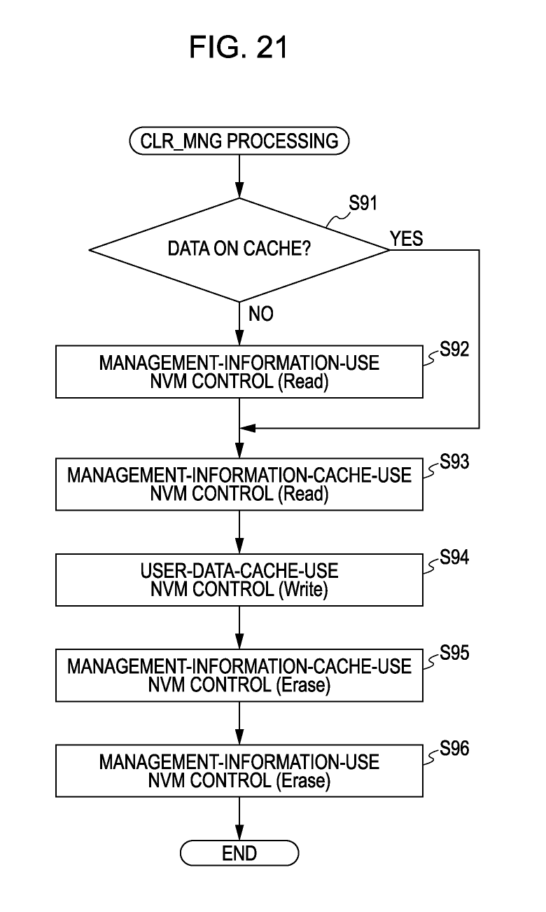

FIG. 21 is a flowchart illustrating processing for the media shown in FIGS. 16 and 17 performed in response to CLR_MNG command.

When the medium detects a CLR_MNG command transmitted from the host 100, whether or not target data is data on the management-information cache memory is determined (Step S91). When the target data is not data on the management-information cache memory, the processing proceeds to Step S92. On the other hand, when the target data is data on the management-information cache memory, the processing proceeds to Step S93.

Next, the management-information-use NVM control section controls read processing for the management information (Step S92). Then, the management-information-cache-use NVM control section controls read processing for the management information (Step S93). Next, the NVM-control selection section switches to the user-data-cache-use NVM control section and the user-data-cache-use NVM control section controls write processing for the user data (Step S94). Finally, while the management-information-cache-use NVM control section controls erase processing for the management information (Step S95), the NVM-control selection section switches to the management-information-use NVM control section and the management-information-use NVM control section controls erase processing for the management information (Step S96).

In the third and fourth embodiments, the user-data-use NVM control section and the management-information-use NVM control section include cache memories respectively. Optimum cache algorithms can be selected for the user data and the management information respectively. As a result, the third and fourth embodiments have similar functions and effects as the first embodiment.

### 5. Fifth Embodiment

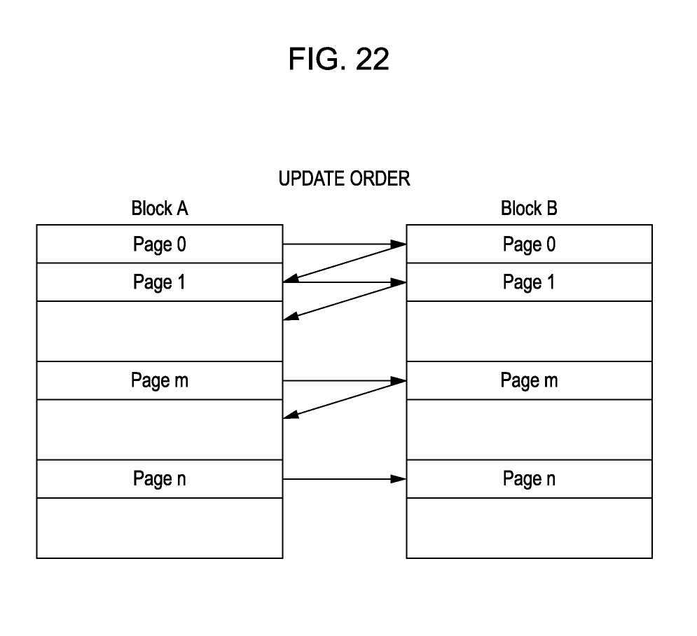

In the fifth embodiment, a same nonvolatile memory device (refer to FIG. 15) is used for the user data and the management information and highly-reliable data storing is realized by switching between NVM control algorithms used for the management information. NVM control circuits in the NVM control section (refer to FIG. 2) may be provided for the user data and the management information respectively, or instead a common NVM control circuit may be provided for the user data and the management information. There are assumed two methods as examples of the NVM control algorithm section 50A in FIG. 2. In either method, pages in two different blocks are assigned to a unit of data. A block corresponds to a physical unit in the nonvolatile memory device. A page corresponds to a unit of controlled data. The two algorithms will be described with reference to FIG. 22 hereinafter.

(1) NVM Control Algorithm-1: Double Writing

When data (one page) is updated, one page in each of block A and block B is updated. In the method, the size of area is doubled and area to be stored is stored in two pages every update.

(2) NVM Control Algorithm-2: Alternate Writing

Every time data (one page) is updated, one page in block A and one page in block B are alternately updated. In the method, the size of area is doubled so as to store data doubly and one page in block A and one page in block B are alternately selected.

In either algorithm, after data is stored to up to final page, two new blocks are assigned and data in old blocks are erased.

### NVM Control Algorithm-1

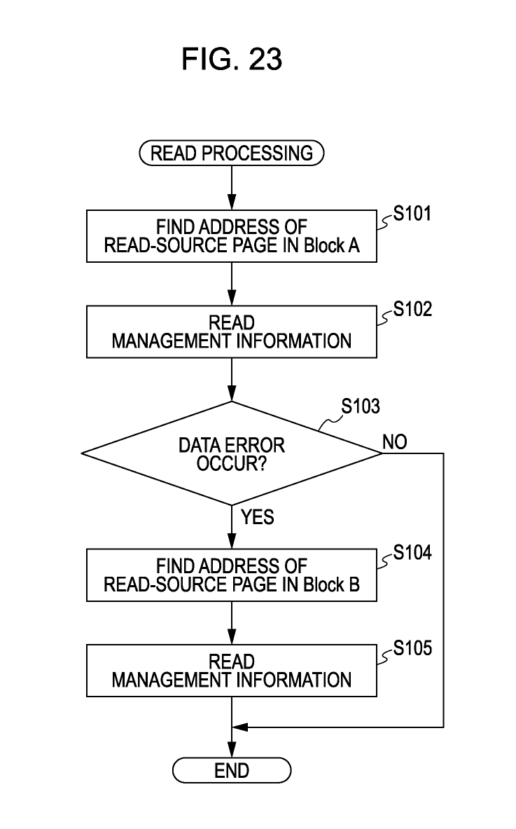

FIG. 23 is a flowchart illustrating read processing based on the NVM control algorithm-1. A management-information-use NVM control section finds an address of read-source page in the block A (Step S101) and reads management information (Step S102). At this time, whether or not a data error occurs is determined (Step S103). When the data error occurs, the processing proceeds to Step S104. When the data error does not occur, the processing is terminated. When in Step S2 it is determined that the data error occurs, an address of read-source page in the block B is found (Step S104). Then, management information is read (Step S105) and the processing is terminated.

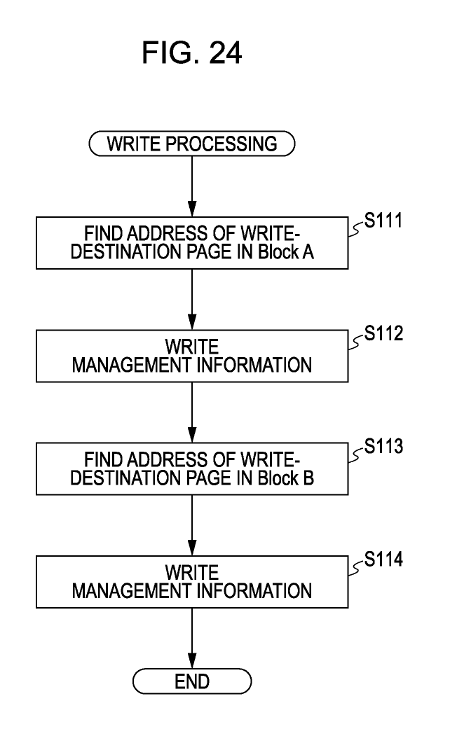

FIG. 24 is a flowchart illustrating write processing based on the NVM control algorithm-1. The management-information-use NVM control section finds an address of write-destination page in the block A (Step S111) and writes management information (Step S112). Next, the management-information-use NVM control section finds an address of write-destination page in the block B (Step S113). Then, management information is written (Step S114) and the processing is terminated.

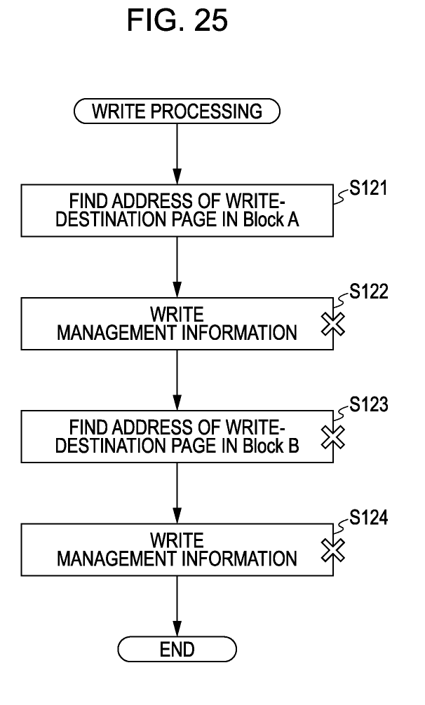

FIG. 25 is a diagram illustrating a case that power-off arises during processing based on the NVM control algorithm-1. Steps S121 to S124 in FIG. 25 correspond to Steps S111 to S114 in FIG. 24, respectively.

There is assumed a case that power-off arises in the condition that a page address of a write destination corresponds to “m”.

(1) a case that power-off arises in Step S122:

A data error occurs in a read-source page m in the block A.

Data read succeeds in a read-source page m−1 in the block B (old management information before being updated).

(2) a case that power-off arises in Step S123:

Data read succeeds in a read-source page m in the block A.

A read-source page m in the block B is in an erased state (new management information after being updated).

(3) a case that power-off arises in Step S124:

Data read succeeds in a read-source page m in the block A.

A data error occurs in a read-source page m in the block B (new management information after being updated).

### NVM Control Algorithm-2

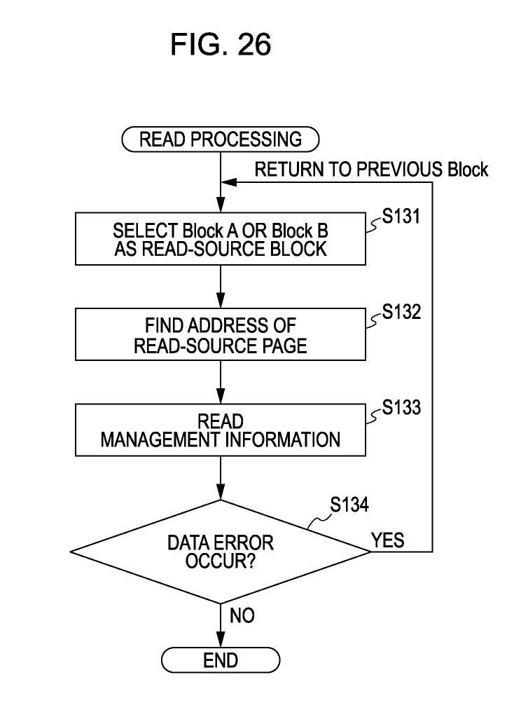

FIG. 26 is a flowchart illustrating read processing based on the NVM control algorithm-2. The management-information-use NVM control section selects the block A or the block B as a read-source block (Step S131), finds an address of read-source page (Step S132), and reads management information (Step S133). At this time, whether or not a data error occurs is determined (Step S134). When the data error occurs, the processing proceeds to Step S131 and the same processing is repeated from the previous block. On the other hand, when the data error does not occur, the processing is terminated.

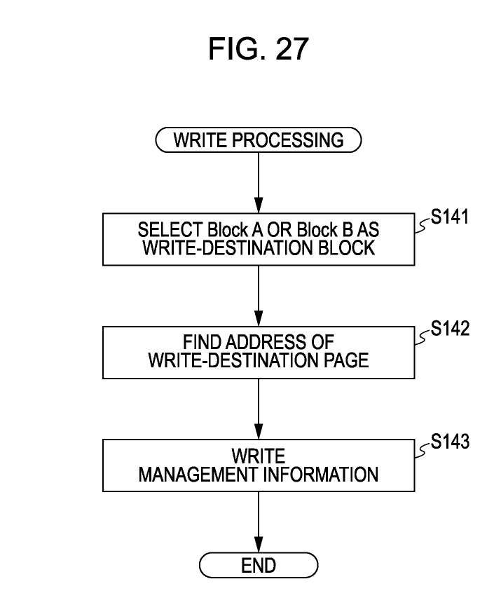

FIG. 27 is a flowchart illustrating write processing based on the NVM control algorithm-2. The management-information-use NVM control section selects the block A or the block B as a write-destination block (Step S141), finds an address of write-destination page (Step S142), and writes management information (Step S143). After Step S133 is completed, the processing is terminated.

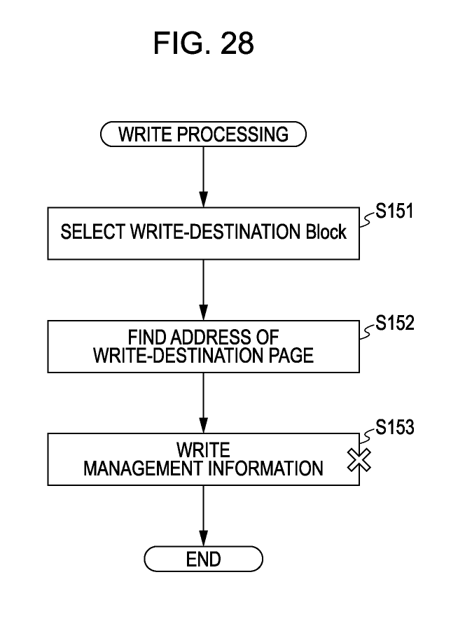

FIG. 28 is a diagram illustrating a case that power-off arises during processing based on the NVM control algorithm-2. Steps S151 to S153 in FIG. 28 correspond to Steps S141 to S143 in FIG. 27, respectively.

There is assumed a case that power-off arises in the condition that an address of write-destination page corresponds to “m”.

The case that power-off arises in Step S153:

(1) a case that a write-destination block is block A A data error occurs in a read-source page m in the block A.

Data read succeeds in a read-source page m−1 in the block B.

(2) a case that a write-destination block is block B

A data error occurs in a read-source page m in the block B.

Data read succeeds in a read-source page m in the block A.

In either case, old management information before being updated is read.

In the above-mentioned embodiment, the probability of data errors occurring in the management information is reduced by taking an adequate countermeasure against concentrated access to management information, the countermeasure being to disperse concentrated access to the management information. In addition, during store processing for the management information, power-off may arise or a medium may be pulled out. Even in such a case, since the same management information is written at two points (double writing), the management information may be stored in a safe condition at either of the two points and data errors are prevented from occurring.

The medium corresponding to an embodiment of the present invention can be realized by using one of the above-mentioned embodiments or combining more than one of the above-mentioned embodiments.

### 6. Sixth Embodiment

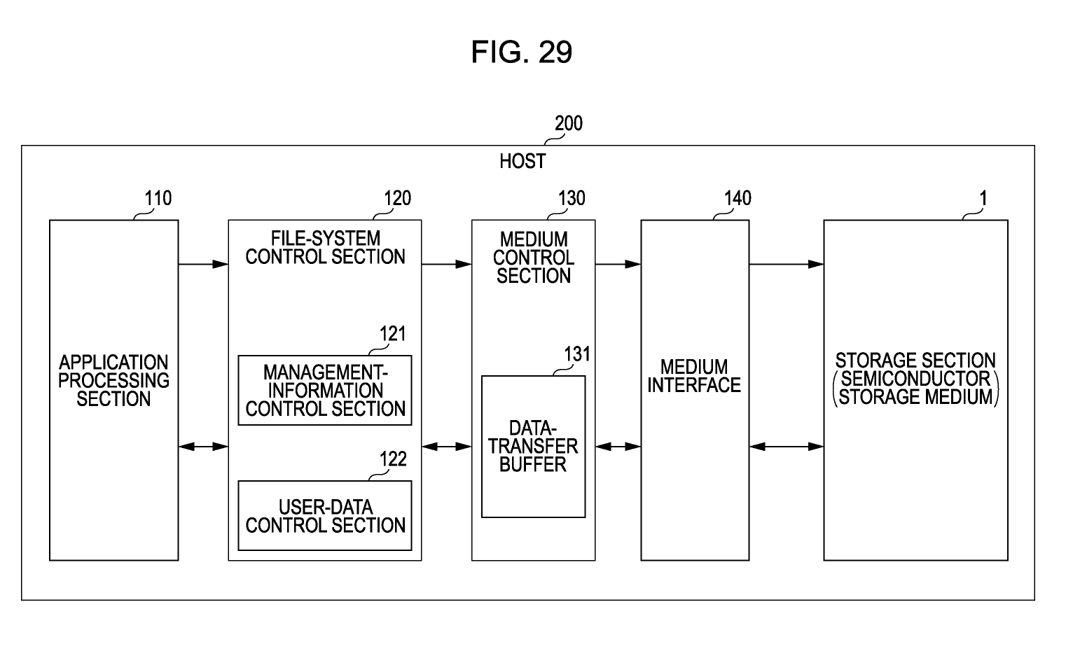

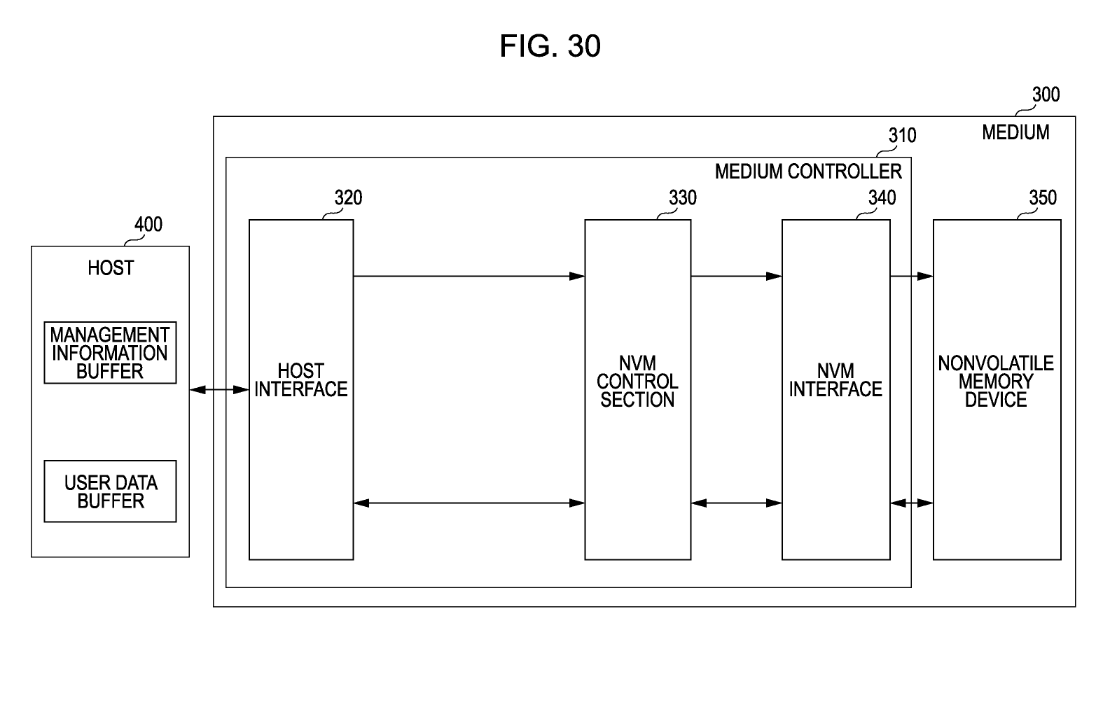

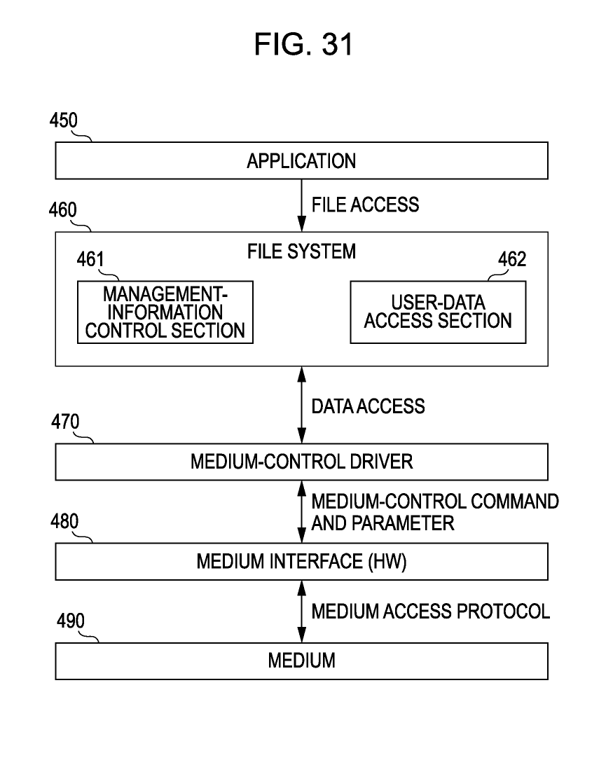

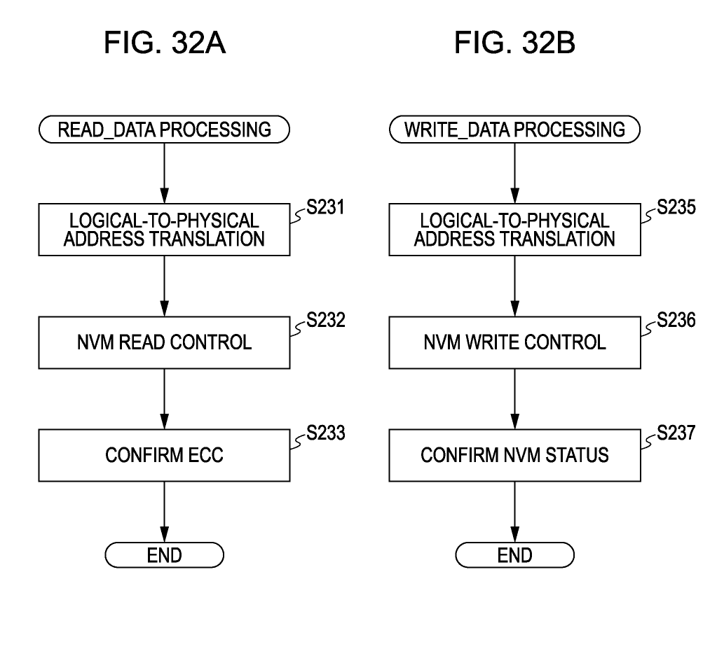

In the sixth embodiment, a host includes a medium, so that the host and the medium are integrated. FIG. 29 is a block diagram illustrating an internal configuration of the host according to the sixth embodiment of the present invention. Compared with the configuration of the host 100 shown in FIG. 3, the host 200 in the sixth embodiment includes the medium 1. In such a configuration, a host device (information recording apparatus) from which a medium is not detached can be provided. In addition, each of media described in the first to the fifth embodiments can be applied to the medium 1. In this case, a function and an effect which each of these embodiments has are obtained.

Series of processing performed in the above-mentioned information processing apparatus can be performed with hardware or software. Needless to say, the function for performing the series of processing is realized by combining hardware with software. When the series of processing is performed with software, a program including the software is installed from a program record medium into a computer embedded in dedicated hardware or a computer, in which various functions can be executed by installing various programs, for example, a general-purpose personal computer.

Then, the processing performed in each step described in the specification includes not only processing performed in temporal sequence along the order described in the specification but, instead of being performed in temporal sequence, processing performed in parallel, in a different order, or individually.

Since the above-mentioned embodiments are specific examples according to embodiments of the present invention, various sorts of technically desirable limitations are added to the above-mentioned embodiments. However, unless limiting the embodiments is described in the descriptions of the above-mentioned embodiments, embodiments of the present invention are not confined to the above-mentioned embodiments. For example, processing time, sequences of processing, and numerical condition of parameters described in the above-mentioned descriptions are just desirable examples. In addition, dimensions, configurations, and arrangements in figures used for descriptions are just used to schematically show an example of the embodiment.

The present application contains subject matter related to that disclosed in Japanese Priority Patent Application JP 2008-330883 filed in the Japan Patent Office on Dec. 25, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A nonvolatile storage device comprising:
nonvolatile memory means for storing user data and management information used to manage the user data on a file system; and
a medium controller configured to determine whether a command input from a host device is used for the user data or the management information, the command describing content of processing performed for the user data or the management information, and switch between control methods used for the nonvolatile memory means on the basis of the determination result.

2. The nonvolatile storage device according to claim 1, wherein the nonvolatile memory means includes
a first nonvolatile memory configured to store the user data, and
a second nonvolatile memory configured to be more reliable at storing data than the first nonvolatile memory and store the management information used to manage the user data on the file system; and
the medium controller controls, on the basis of the command input from the host device and describing content of processing performed for the user data or the management information, switching between the first nonvolatile memory and the second nonvolatile memory and storing data.

3. The nonvolatile storage device according to claim 2, wherein the medium controller includes
a host interface configured to acquire the command input from the host device and used for the user data or the management information;
a protocol discrimination section configured to determine whether the command is used for the user data or the management information on the basis of a protocol used for the command, the command being acquired by the host interface and used for the user data or the management information;
a first nonvolatile memory control section configured to control the first nonvolatile memory;
a second nonvolatile memory control section configured to control the second nonvolatile memory; and
a nonvolatile memory control selection section configured to switch between the first nonvolatile memory control section and the second nonvolatile memory control section on the basis of the determination result of the protocol discrimination section.

4. The nonvolatile storage device according to claim 1, wherein the medium controller controls appending of an error-correcting code to the management information and storing the management information, the error-correcting code having higher error correcting capability than the user data, when the command input from the host device is used for the management information, the command describing content of processing performed for the user data or the management information.

5. The nonvolatile storage device according to claim 4, wherein
the nonvolatile memory means includes a nonvolatile memory; and
the medium controller includes
a host interface configured to acquire the command input from the host device and used for the user data or the management information,
a protocol discrimination section configured to determine whether the command is used for the user data or the management information on the basis of a protocol used for the command, the command being acquired by the host interface and used for the user data or the management information,
a first nonvolatile memory control section configured to include a first error-correcting circuit used for appending a first error-correcting code to data to be stored and control the nonvolatile memory,
a second nonvolatile memory control section configured to include a second error-correcting circuit for appending a second error-correcting code to data to be stored, the second error-correcting code having higher error correcting capability than the first error-correcting code, and control the nonvolatile memory, and
a nonvolatile memory control selection section configured to switch between the first nonvolatile memory control section and the second nonvolatile memory control section on the basis of the determination result of the protocol discrimination section.

6. The nonvolatile storage device according to claim 1, wherein the medium controller controls writing of the management information twice in the nonvolatile memory when the command input from the host device is used for the management information, the command describing content of processing performed for the user data or the management information.

7. The nonvolatile storage device according to claim 5, wherein the medium controller includes
a host interface configured to acquire the command input from the host device and used for the user data or the management information;
a protocol discrimination section configured to determine whether the command is used for the user data or the management information on the basis of a protocol used for the command, the command being acquired by the host interface and used for the user data or the management information; and
a nonvolatile memory control section configured to control writing of the management information twice in the nonvolatile memory when the determination result of the protocol discrimination section indicates that the command is used for the management information.

8. An information recording system comprising:
a host device configured to include
an application processing section configured to execute a file-access instruction,
a file-system control section configured to generate a command, which describes content of processing performed for user data or management information, on the basis of the file-access instruction executed by the file-system control section, the management information being used to manage the user data on a file system, and
a medium control section configured to transfer the command used for the user data or the management information to a nonvolatile storage device;
nonvolatile memory means for storing the user data and the management information being used to manage the user data on the file system; and
a medium controller configured to determine whether a command input from the host device is used for the user data or the management information, the command describing content of processing performed for the user data or the management information, and switch between control methods used for the nonvolatile memory means on the basis of the determination result.

9. An information recording method comprising the steps of:
receiving a command input from a host device, the command describing whether data to be a processing object is user data or management information;
determining whether the received command is used for the user data or the management information;
switching between control methods used for nonvolatile memory means on the basis of the determination result, the nonvolatile memory means storing the user data and the management information being used to manage the user data on a file system; and
recording the user data or the management information in the nonvolatile memory means according to the control method switched to.

10. A nonvolatile storage device comprising:
a nonvolatile memory configured to store user data and management information used to manage the user data on a file system; and
a medium controller configured to determine whether a command input from a host device is used for the user data or the management information, the command describing content of processing performed for the user data or the management information, and switch between control methods used for the nonvolatile memory on the basis of the determination result.
